(19) United States
(12) Patent Application Publication
(10) Pub. No.: US 2012/0224472 A1
(43) Pub. Date: Sep. 6, 2012

(54) METHOD FOR RELAYING OF BASE STATION, METHOD FOR RELAYING OF TERMINAL AND METHOD FOR TRANSMITTING

(75) Inventors: Eunkyung KIM, Daejeon (KR); Sung Kyung KIM, Daejeon (KR); Sung Cheol CHANG, Daejeon (KR); Hyun LEE, Daejeon (KR); Chul Sik YOON, Daejeon (KR); Won-Ik KIM, Daejeon (KR); Mi-Young YUN, Daejeon (KR); Kwang Jae LIM, Daejeon (KR)

(73) Assignee: ELECTRONICS AND TELECOMMUNICATIONS RESEARCH INSTITUTE, Daejeon (KR)

(21) Appl. No.: 13/412,596

(22) Filed: Mar. 5, 2012

(30) Foreign Application Priority Data
Mar. 4, 2011 (KR) 10-2011-0019667
Apr. 5, 2011 (KR) 10-2011-0031328
May 6, 2011 (KR) 10-2011-0043142
Jul. 11, 2011 (KR) 10-2011-0068536
Jul. 11, 2011 (KR) 10-2011-0068537
Jul. 11, 2011 (KR) 10-2011-0068538
Jul. 11, 2011 (KR) 10-2011-0068545
Jul. 12, 2011 (KR) 10-2011-0068711
Oct. 31, 2011 (KR) 10-2011-0112477
Oct. 31, 2011 (KR) 10-2011-0112479
Mar. 2, 2012 (KR) 10-2012-0022059
Mar. 2, 2012 (KR) 10-2012-0022060
Mar. 2, 2012 (KR) 10-2012-0022061
Mar. 2, 2012 (KR) 10-2012-0022062
Mar. 2, 2012 (KR) 10-2012-0022063

(51) Int. Cl. H04W 40/00

(52) U.S. Cl. 370/226; 370/315

(57) ABSTRACT

A method of relaying in a base station (BS) includes: setting, when a backhaul link of a first BS is damaged, a relay link using a second BS, which is an adjacent BS of the first BS as a serving BS; and releasing the relay link after the backhaul link is recovered.

### CROSS-REFERENCE TO RELATED APPLICATION

This application claims priority to and the benefit of Korean Patent Application No. 10-2011-0019667, No. 10-2011-0031328, No. 10-2011-0043142, No. 10-2011-0068537, No. 10-2011-0068538, No. 10-2011-0068536, No. 10-2011-0068545, No. 10-2011-0068711, No. 10-2011-0112477, No. 10-2011-0112479, No. 10-2012-0022061, No. 10-2012-0022063, No. 10-2012-0022062, No. 10-2012-0022059, and No. 10-2012-0022060 filed in the Korean Intellectual Property Office on Mar. 4, 2011, Apr. 5, 2011, May 6, 2011, Jul. 11, 2011, Jul. 11, 2011, Jul. 11, 2011, Jul. 11, 2011, Jul. 12, 2011, Oct. 31, 2011, Oct. 31, 2011, Mar. 2, 2012, Mar. 2, 2012, Mar. 2, 2012, Mar. 2, 2012, and Mar. 2, 2012, respectively, the entire contents of which are incorporated herein by reference.

### BACKGROUND OF THE INVENTION

(a) Field of the Invention The present invention relates to a method of relaying in a base station, a method of relaying in a terminal, and a method of transmitting in a terminal.

(b) Description of the Related Art

When a disaster or accident occurs, important parts of societal infrastructure may be broken or damaged. Various communication facilities such as wireless phones, wired phones, and the Internet network are important parts of societal infrastructure, and when such a communication facility is broken or damaged in a disaster or accident situation, societal congestion increases and restoration of society may be difficult. Therefore, in such a case, high reliability support of a means to quickly recover or replace a communication facility is important. In a high reliability support, a mobile communication system (HR-Network) should satisfy the following requirements.

First, the HR-Network should satisfy backward compatibility with an existing system, i.e., a system such as a Wireless MAN-OFDMA or Wireless MAN-Advanced Interface. Next, an HR-base station (HR-BS), an HR-mobile station (HR-MS), and an HR-relay station (HR-RS) should be able to perform a multi-mode operation that performs a role of other stations in addition to the respective roles thereof.

Even when an HR-BS, an HR-RS, or a wireless link is unavailable, i.e., even when a single point of failure (SPOF) occurs, communication should be maintained. Direct communication between other HR-MSs should be able to be performed. Multicast transmission, i.e., enhanced multicast communication, should be available within a network, and path management that manages path setting and forwarding for data transmission/reception should be available.

Particularly, for multi-mode operation, an HR-BS performs a role of an

HR-RS according to a situation of a backhaul link, or when an HR-BS or an HR-RS is absent, an HR-MS should perform a role of an HR-BS or an HR-RS. However, in the conventional art, only requirements for a multi-mode operation exist, and because technology regarding a method of continuously providing a service while a multi-mode operation does not exist, countermeasures are needed.

### SUMMARY OF THE INVENTION

The present invention has been made in an effort to provide a method of relaying in a BS (base station), a method of relaying in a terminal (MS), and a method of transmitting in an MS having advantages of continuously servicing to a subordinate MS through a multi-mode operation when a backhaul link of a BS is damaged in a communication system, and more particularly, performing a role of a relay station (RS) as a BS establishes a relay link with an adjacent BS and smoothly restoring to an original BS when a backhaul link is recovered.

The present invention has been made in an effort to further provide a method of relaying in a BS, a method of relaying in an MS, and a method of transmitting in an MS having advantages of performing a smooth communication business as an MS performs a role of a BS or an RS.

The present invention has been made in an effort to further provide a method of relaying in a BS, a method of relaying in an MS, and a method of transmitting in an MS having advantages of transmitting a control message and continuously performs a transmission service when an MS performs a role of a BS or an RS in a communication system.

An exemplary embodiment of the present invention provides a method of relaying in a BS including: establishing, when a backhaul link of a first BS is damaged, a relay link using a second BS, which is an adjacent BS of the first BS as a serving BS; and releasing the relay link after the backhaul link is recovered

The release of the relay link may include transmitting, by the second BS, a handover request message that requests to perform handover to the first BS to an MS.

The release of the relay link may be performed through the recovered backhaul link.

An MS may wait until the first BS operates as a BS, and when the first BS operates as a BS, the MS may perform network reentry.

Another embodiment of the present invention provides a method of relaying in a BS, the method including: establishing, when a backhaul link of a first BS is damaged, a relay link between a first BS and a second BS, which is a serving BS; and notifying, by the first BS, the second BS that damage of the backhaul link is recovered, wherein the notifying of the second BS is performed through the recovered backhaul link.

Yet another embodiment of the present invention provides a method of relaying in a BS, the method including: scanning, when a backhaul link of a first BS is damaged, a downlink channel; synchronizing with a second BS that is connected to the backhaul link; acquiring a downlink parameter or an uplink parameter; performing ranging; and forming an operation parameter necessary for a relay link.

The method may further include: performing authentication, authority verification, and password exchange, if necessary; and performing re-registration with the second BS, if necessary.

Yet another embodiment of the present invention provides a method of relaying in a BS, the method including: establishing, by a first BS, a relay link with a second BS that is connected to a backhaul link; and providing, by the first BS, a service.

The method may further include notifying a subordinate apparatus to perform handover of establishment of the relay link, if necessary.

Yet another embodiment of the present invention provides a method of relaying in a BS, the method including: transmitting, by a first BS in which a backhaul link is damaged, a relay establishment request message to a second BS in which a backhaul link is connected; and receiving, by the first BS, a relay establishing response message including acceptance, rejection, and re-request from the second BS.

Yet another embodiment of the present invention provides a method of relaying in an MS, the method including: reporting, by the MS, a capability of the MS for a role of an RS to a BS; and performing, by the MS, a role of the RS.

The reporting of a capability of the MS may be performed in a process in which the MS performs initial access; and the performing of a role of the RS may be determined by the BS.

Yet another embodiment of the present invention provides a method of relaying in an MS, the method including: receiving, by the MS, a relay establishing request message from a BS; and transmitting, by the MS, a relay establishing response message to the BS.

The relay establishing request message may include a relay mode including a time-division transmit & receive (TTR) mode or a simultaneous transmit & receive (STR) mode.

The method may further include operating, by the MS, as an RS as a relay link is established to the MS, wherein the operating of as an RS may include maintaining, by the MS, a function of the MS.

Yet another embodiment of the present invention provides a method of relaying in an MS, the method including: transmitting, by the MS to which a relay link is established, a relay link release request message to a BS; and receiving, by the MS, a relay link release response message from the BS.

The relay link release response message may include an action time, and the method may further include transmitting, by the MS, a re-request to the BS after the action time has expired.

The MS may release a relay mode immediately or after the action time is complete, after the relay link release response message is received.

The relay link release response message may include a rejection, and the MS may maintain the relay link when the MS receives the rejection.

Yet another embodiment of the present invention provides a method of transmitting in an MS, the method including: operating the MS in a multi-mode; and transmitting a control message for supporting the multi-mode to a subordinate apparatus.

The transmitting of a control message may be performed when a backhaul link is damaged or recovered.

The transmitting of a control message may be performed in at least one of when a backhaul link is damaged or recovered, when it is necessary to reconfigure a parameter of at least one of a physical layer PHY and an MAC layer while the MS maintains a relay link as the backhaul link is unavailable, and when notifying establishment, release, or a change of the multi-mode to the subordinate apparatus, and when it is necessary to reconfigure a parameter of at least one of a physical layer PHY and an MAC layer may include at least one of power down, power reduction, and a frequency allocation (FA) change.

Yet another embodiment of the present invention provides a method of transmitting in a BS, the method including: operating the BS in a multi-mode; and transmitting a control message for supporting the multi-mode to a subordinate apparatus.

### BRIEF DESCRIPTION OF THE DRAWINGS

FIG. 1 is a diagram illustrating a general communication situation.

FIG. 2 is a diagram illustrating an example in which a BS establishes a relay link when a backhaul link is damaged according to an exemplary embodiment of the present invention.

FIG. 3 is a diagram illustrating an example in which a BS establishes a relay link when a backhaul link is damaged according to another exemplary embodiment of the present invention.

FIG. 4 is a diagram illustrating an example in which a BS establishes a relay link when a backhaul link is damaged according to another exemplary embodiment of the present invention.

FIG. 5 is a diagram illustrating an example in which a BS establishes a relay link when a backhaul link is damaged according to another exemplary embodiment of the present invention.

FIG. 6 is a flowchart illustrating a method of operating a BS when a backhaul link is recovered according to another exemplary embodiment of the present invention.

FIG. 7 is a flowchart illustrating a method of operating a BS when a backhaul link is recovered according to another exemplary embodiment of the present invention.

FIG. 8 is a flowchart illustrating a method of relaying in a BS according to an exemplary embodiment of the present invention.

FIG. 9 is a flowchart illustrating a method of relaying in a BS according to another exemplary embodiment of the present invention.

FIG. 10 is a flowchart illustrating a method of relaying in an MS according to another exemplary embodiment of the present invention.

FIG. 11 is a flowchart illustrating a method of transmitting in an MS according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile station (MS) may indicate a terminal, a mobile terminal (MT), a subscriber station (SS), a portable subscriber station (PSS), an access terminal (AT), user equipment (UE), an advanced mobile station (AMS), and a high reliability mobile station (HR-MS), and may include an entire function or a partial function of the terminal, the MT, the SS, the PSS, the AT, the UE, the AMS, and the HR-MS.

Further, a base station (BS) may indicate a node B, an evolved node B (eNode B), an access point (AP), a radio access station (RAS), a base transceiver station (BTS), a mobile multihop relay (MMR)-BS, an advanced base station (ABS), a high reliability base station (HR-BS), a relay station (RS) that performs a function of the BS, an advanced relay station (ARS), and a high reliability relay station (HR-RS) that performs a function of the BS, and may include an entire function or a partial function of the node B, the eNode B, the AP, the RAS, the BTS, the MMR-BS, the ABS, the HR-BS, the RS, the ARS, and the HR-RS.

Hereinafter, a method of relaying in a base station will be described in detail with reference to the drawings.

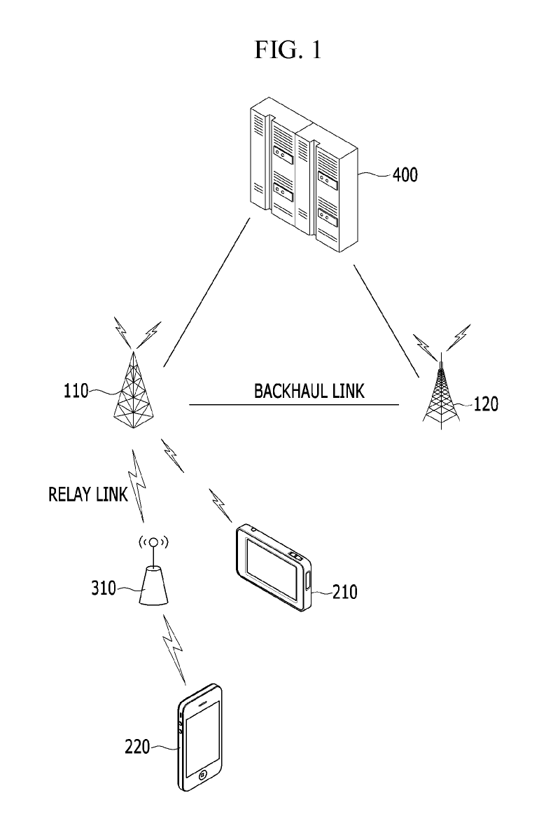

FIG. 1 is a diagram illustrating a general communication situation,

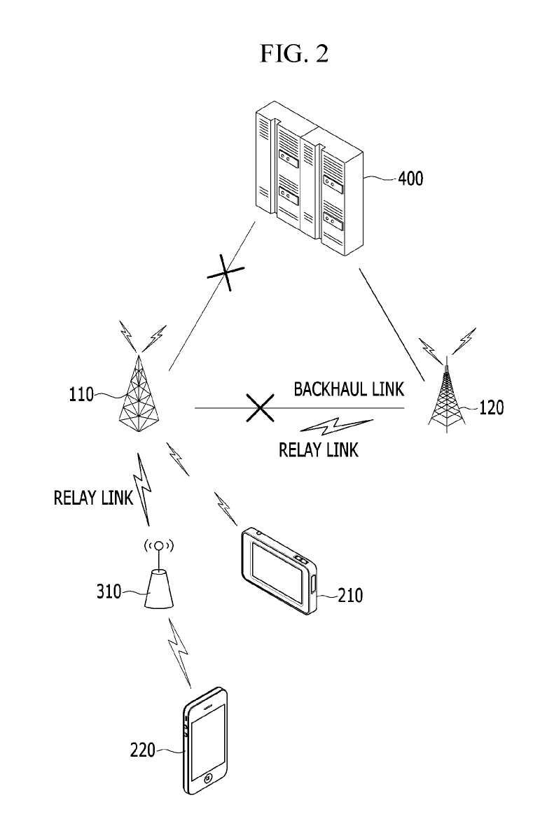

FIG. 2 is a diagram illustrating an example in which a BS establishes a relay link when a backhaul link is damaged according to an exemplary embodiment of the present invention,

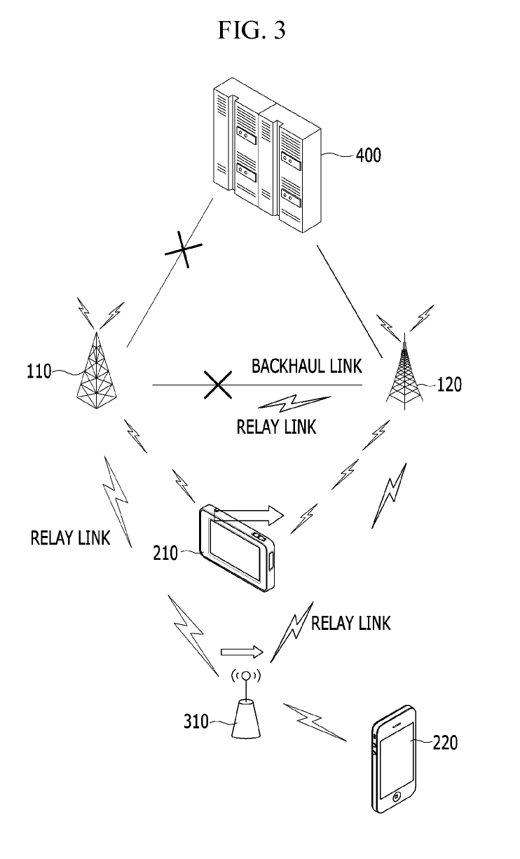

FIG. 3 is a diagram illustrating an example in which a BS establishes a relay link when a backhaul link is damaged according to another exemplary embodiment of the present invention,

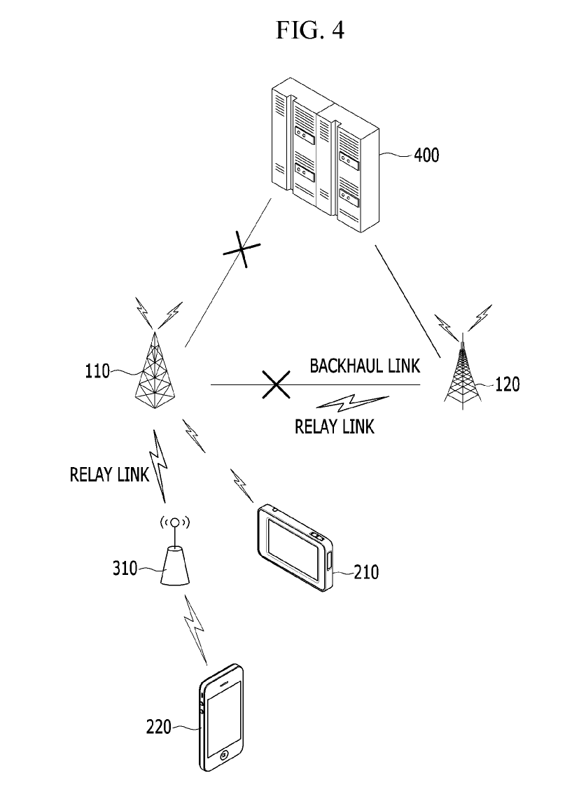

FIG. 4 is a diagram illustrating an example in which a BS establishes a relay link when a backhaul link is damaged according to another exemplary embodiment of the present invention, and

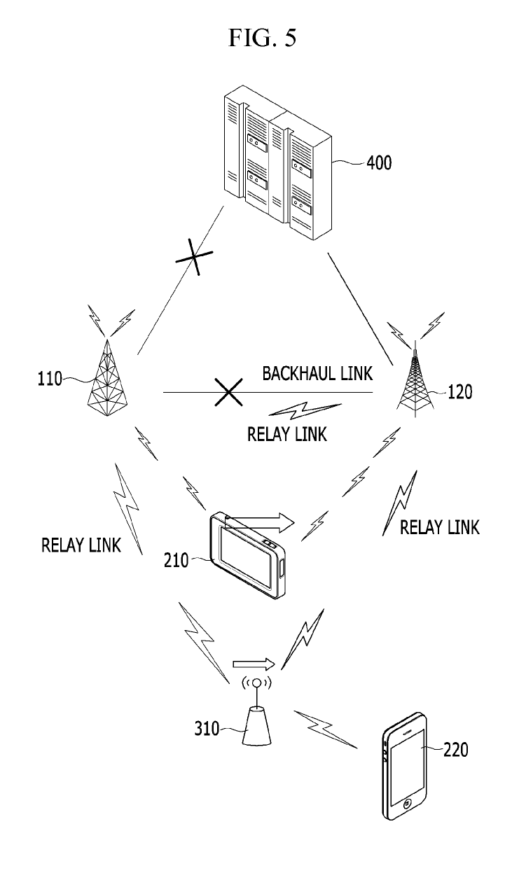

FIG. 5 is a diagram illustrating an example in which a BS establishes a relay link when a backhaul link is damaged according to another exemplary embodiment of the present invention.

Referring to FIG. 1, a general communication system includes a server 400 that manages BSs 110 and 120, an MS 210 that transmits and receives to and from the BS 110, and an MS 220 that communicates with the BS 110 through an RS 310 to which a relay link is established. In this case, the BSs 110 and 120 are connected by a backhaul link.

When a backhaul link of the BS 110 is collapsed, the BS 110 temporally establishes a relay link with the BS 120 and performs a role of an RS. In this case, the BS 110 should provide a continuous service to a subordinate RS 310 in which a relay link is established with the BS 110, a subordinate MS 210 that transmits and receives to and from the BS 110, and a subordinate MS 220 that is connected to the RS 310.

FIG. 2 illustrates a case where the BS 110 is recognized as a BS by the subordinate RS 310 or the subordinate MS 210 even if a backhaul link of the BS 110 is collapsed.

In FIG. 2, the BS 110 and the BS 120 establish a relay link and notify the subordinate MS 210 of such a fact, or performs a role of a BS without notification of such a fact and services only data that should be transmitted to a superordinate server 400 through a relay link with the BS 120. In this case, the BS 110 performs a function of a BS while maintaining configuration information for operating a previous BS or performs a role of a BS based on a new network configuration information that it receives from the BS 120.

FIG. 3 illustrates a case where the BS 110 requests handover to the BS 120 from the subordinate RS 310 or the subordinate MS 210 when a backhaul link of the BS 110 is collapsed. In response to a handover request of the BS 110, the subordinate RS 310 and the subordinate MS 210 perform handover to the BS 120 or temporally stop communication until relay link establishment of the BS 110 is complete. Further, in order to perform an efficient handover process, the BS 110 shares MAC context information with the BS 120 of the subordinate RS 310 and the subordinate MS 210 between the BS 120 and the BS 110. The BS 110 performs such sharing through a backhaul link before the backhaul link is collapsed, and performs such sharing through a preset relay link if the backhaul link is collapsed. When a backhaul link is recovered, a relay link that is established with the BS 120 is unnecessary and thus the BS 110 performs relay link release. In this case, the BS 110 requests callback handover that calls back the subordinate RS 310 or the subordinate MS 210 in which handover to the BS 120 is performed from the BS 120, thereby returning the subordinate RS 310 or the subordinate MS 210 from the BS 120.

FIG. 4 illustrates a case where the BS 110 is recognized as an RS by the subordinate RS 310 or the subordinate MS 210 when a backhaul link of the BS 110 is collapsed.

In this case, the BS 110 performs a role as a subordinate RS of the BS 120. That is, the BS 110 may perform a method of establishing a new relay link with the subordinate RS 310 or a method of reusing a previously established relay link.

FIG. 5 illustrates a case where the BS 110 requests handover to the BS 120 from the subordinate RS 310 or the subordinate MS 210 if the BS 110 needs to change its operation mode to an RS operation mode when a backhaul link of the BS 110 is collapsed. In response thereto, the subordinate MS 210 performs handover to the BS 120 or temporally stops communication until relay link establishment of the BS 110 is complete. In order to start a relay link with the BS 110, the subordinate RS 310 temporally stops communication. In order to perform an efficient handover process, the BS 110 shares MAC context information with the BS 120 of the subordinate RS 310 and the subordinate MS 210 between the BS 120 and the BS 110. In this case, the BS 110 may perform a sharing procedure, as in a case of FIG. 3, perform release when a backhaul link is recovered, and perform callback handover to the BS 120.

When a backhaul link is collapsed, in order for the BS 110 to temporally perform a role of an RS with the adjacent BS 120 through a relay link and to retuen its mode from an RS operation mode to an original BS mode, a procedure that notifies or deregisters corresponding contents to the server 400 or the adjacent BS 120 to an original BS mode is necessary. Before starting a release action, the BS 110 enables the subordinate MS 210 or the subordinate RS 310 to perform handover to another BS, or instructs to request a service to another BS or an RS. Alternatively, when it is unnecessary to receive a service from an adjacent BS or an RS until a release action completion time, the MS 210 waits until the BS 110 in a present RS operation mode returns back to the original BS and performs network reentry after release, thereby resuming a service.

In this way, according to an exemplary embodiment of the present invention, when a backhaul link of a BS is damaged, the BS establishes a relay link with an adjacent BS and performs a role of an RS, thereby performing a smooth communication function.

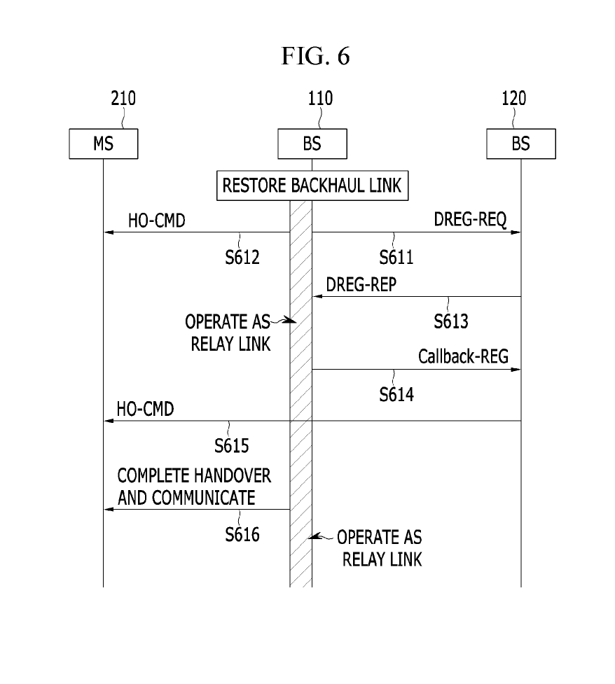

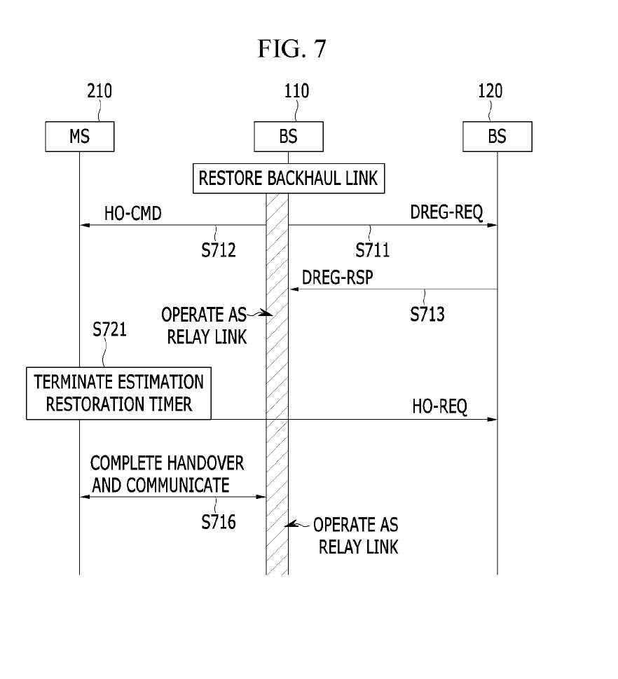

Hereinafter, a method of releasing a relay link according to another exemplary embodiment of the present invention will be described in detail with reference to FIGS. 6 and 7.

FIG. 6 is a flowchart illustrating an example in which a BS establishes a relay link when a backhaul link is damaged according to an exemplary embodiment of the present invention, FIG. 3 is a diagram illustrating an example in which a BS establishes a relay link when a backhaul link is damaged according to another exemplary embodiment of the present invention, FIG. 4 is a diagram illustrating an example in which a BS establishes a relay link when a backhaul link is damaged according to another exemplary embodiment of the present invention, and FIG. 5 is a diagram illustrating an example in which a BS establishes a relay link when a backhaul link is damaged according to another exemplary embodiment of the present invention.

Referring to FIG. 1, a general communication system includes a server 400 that manages BSs 110 and 120, an MS 210 that transmits and receives to and from the BS 110, and an MS 220 that communicates with the BS 110 through an RS 310 to which a relay link is established. In this case, the BSs 110 and 120 are connected by a backhaul link.

If a backhaul link of the BS 110 is collapsed, the BS 110 temporally establishes a relay link with the BS 120, and the BS 110 performs a role of an RS. In this case, the BS 110 should provide a continuous service to the subordinate RS 310 in which a relay link is established with the BS 110, the subordinate MS 210 that transmits and receives to and from the BS 110, and the subordinate MS 220 that is connected to the RS 310.

When a backhaul link is collapsed, in order for the BS 110 to temporally perform a role of an RS with the adjacent BS 120 through a relay link and to retuen its mode from an RS operation mode to an original BS mode, it is necessary to notify or deregister corresponding contents to the server 400 or the adjacent BS 120. Before starting a release action, the BS 110 enables the subordinate MS 210 or the subordinate RS 310 to perform handover to another BS, or instructs to request a service from another BS or an RS. Alternatively, when it is unnecessary to receive a service from an adjacent BS or an RS until a release action completion time, the MS 210 waits until the BS 110 in a present RS operation mode returns back to an original BS and performs network reentry after release, thereby resuming a service.

In this way, according to an exemplary embodiment of the present invention, when a backhaul link of a BS is damaged, the BS establishes a relay link with an adjacent BS and performs a role of an RS, thereby performing a smooth communication operation.

Hereinafter, a method of releasing a relay link according to another exemplary embodiment of the present invention will be described in detail with reference to FIGS. 6 and 7.

FIG. 6 is a flowchart illustrating a method of operating a BS when a backhaul link is recovered according to an exemplary embodiment of the present invention, and FIG. 7 is a flowchart illustrating a method of operating a BS when a backhaul link is recovered according to another exemplary embodiment of the present invention.

Because the backhaul link was recovered, a necessary process upon performing a release action with recovery of a backhaul link may be performed using the backhaul link or using an already established relay link. Further, when recovery of the backhaul link is predicted, a necessary process may be previously performed through an already established relay link.

Referring to FIGS. 6 and 7, the relay mode BS 110 to perform deregistration first transmits a deregistration request message (DREG-REQ) to the adjacent BS 120 (S611 and S711).

The BS 110 transmits a handover request message (HO-CMD) to the adjacent BS 120 while requesting deregistration from the subordinate MS 210 (S612 and S712). In this case, the BS 120 stores MS related information and quickly resumes a service for the MS 210 that returns to a service zone. Further, the BS 110 transmits information of a recommended BS 120 when performing handover, a callback handover available time, and a service resumption start time after the BS 110 is converted to a BS mode to the MS 210, thereby assisting service resumption.

When the BS 110 is converted to a BS mode, if the MS 210 cannot perform handover to the BS 120 or the RS 310 until a service resumption start time, if the MS 210 is in a state such as a sleep mode or an idle mode, or if it is unnecessary to perform handover, the BS 110 stays in a present cell until a service resumption start time, and after being converted to a BS mode, the BS 110 performs network reentry.

The BS 110 requests to establish a relay link with the BS 120 from the subordinate RS 310. In this case, the BS 110 stores corresponding subordinate RS related information and restores a relay link when a service to the BS is resumed. In this case, the BS 110 transmits information of the BS 120, callback handover available time, and a service resumption start time after changing its mode to a BS mode to the subordinate RS 310, thereby assisting service resumption.

Thereafter, the BS 120 transmits a deregistration response message (DREG-RSP) to the BS 110 (S613 and S713). For this purpose, at least one of the following conditions should be satisfied.

First, in order to transmit a DREG-RSP, the MS 210 within the BS 110 should complete handover to the BS 120. Next, the RS 310 within the BS 110 should complete setting of a relay link with the BS 120. Next, a specific timer, i.e., a release completion estimation time, is established regardless of whether the MS 210 performs handover to the BS 120, and a corresponding timer should expire (S713).

When the release is complete, the BS 110 no longer operates in a relay mode, releases a relay link with the BS 120, and operates as a BS.

Thereafter, in a process of releasing a relay link, the BS 110 requests a message, i.e., a callback handover request message (Callback-REQ), that requests to return the RS 310 that performs handover to the BS 120 or that establishes a relay link to the BS 110, from the BS 120 (S614). In this case, the BS 110 may quickly resume a service or request related information from the BS 120 and receive related information from the BS 120 using the MS 210 and the RS 310 related information that is stored upon previously releasing. Further, the BS 110 requests the stored information from the MS 210 and performs optimum handover to the MS 210 that performs callback handover.

Thereafter, the BS 120 transmits an HO-CMD to the MS 210 (S615). Further, after handover is complete, communication between the MS 210 and the BS 110 is resumed (S616 and S716).

A procedure in which the BS 110 releases a relay link may be performed by a request of the BS 110, but a relay link of the BS 110 may be released by a request of the BS 120. In this case, the BS 120 forwards a DREG-RSP to the BS 110 and performs the above-described release process in response thereto and establishes a relay link with another BS, or the BS 120 operates as a network that performs a role without backhaul link communication i.e., a standalone network. In this case, when a BS establishes a relay link with another BS, an RS performs handover between BSs, and an operation in which an RS performs handover may be performed equally to or similarly to operation in which an MS performs handover. In a process of performing release, a timer such as a request duration (REQ-Duration) is included in a DREG-RSP, and when a corresponding timer has expired, a deregistration request message is retransmitted, or after a backhaul link and a relay link coexist, a time point at which deregistration of a relay link is complete may be notified. Further, the BS 120 may reject release. In this case, the BS 110 may maintain a relay link with the BS 120. A release estimated time of a backhaul link may be a time corresponding to an REQ-Duration.

In this way, according to an exemplary embodiment of the present invention, when a backhaul link of a BS is damaged, the BS performs a role of an RS by establishing a relay link with an adjacent BS, and a mode of the BS is returned back to an original BS mode after a backhaul link is recovered, thereby performing a smooth communication operation.

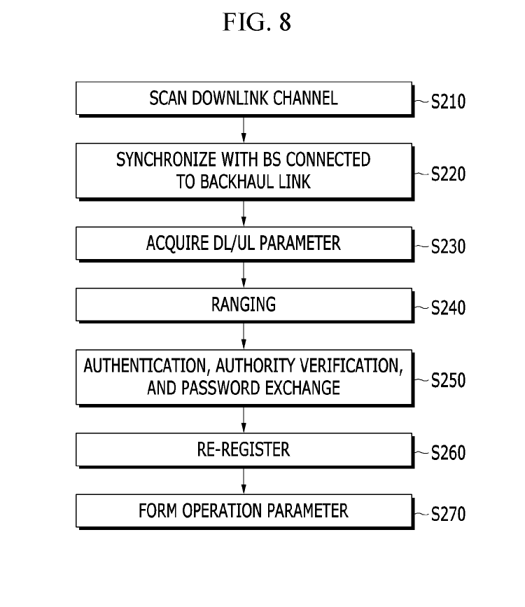

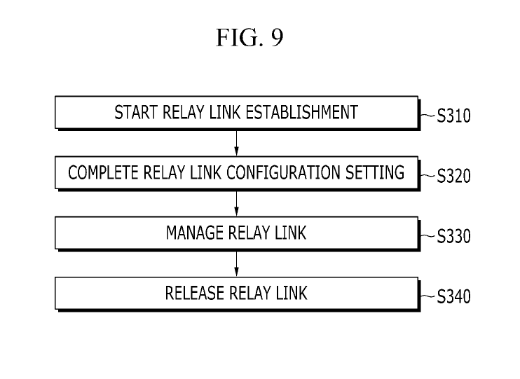

Hereinafter, a method of managing the subordinate MS 210 in a process of establishing a relay link while the BS 110 performs a BS service will be described in detail with reference to FIGS. 8 and 9.

FIG. 8 is a flowchart illustrating a method of relaying in a BS according to an exemplary embodiment of the present invention, and FIG. 9 is a flowchart illustrating a method of relaying in a BS according to another exemplary embodiment of the present invention.

Unlike the step in which a conventional RS establishes a relay link when a backhaul link of a BS is damaged, a relay link is established through the following process.

First, a BS scans a downlink channel (S210), and the BS synchronizes with a BS that is connected to a backhaul link (S220). Thereafter, the BS acquires a downlink and uplink parameter from a superframe header (S230). Thereafter, the BS performs ranging (S240), and the BS starts a relay link using a relay establishing request message (AAI-MMRS-REQ)/RSP message. The BS performs authentication, authority verification, and password exchange, if necessary (S250), and because the BS is being already serviced, such a process may be omitted. Further, the BS performs (re)registration with the BS, if necessary (S260), and because the BS is being already serviced, a registration procedure may be omitted. Thereafter, the BS forms an operation parameter (S270).

Referring again to FIG. 3, a process of establishing a relay link with another BS includes a step of starting relay link establishment including capability negotiation according to a capability of a BS in which a backhaul link is disconnected (S310), i.e., a step of using an AAI-MMRS-REQ/RSP message, a step of completing relay link establishment (S320), i.e., step of forming an operation parameter, a step of managing a relay link after setting is complete (S330), and a step of releasing a relay link (S340).

First, the start step (S310) including a relay link establishment capability report of a BS will be described.

Setting of a relay link between a BS (hereinafter, a subordinate BS) in which a backhaul link is disconnected and a BS (hereinafter, a superordinate BS) in which a backhaul link is connected or an RS may be performed by a request of the subordinate BS or may be performed as the superordinate BS requests to the subordinate BS. The subordinate BS may operate with time-division transmit and receive (TTR) or simultaneous transmit and receive (STR) according to a capability of a BS.

Such a capability may be shared by an interface through a backbone network between BSs before a backhaul link is disconnected, and may be shared in a situation in which a backhaul link is disconnected or immediately before a disconnection of a backhaul link is predicted. In a situation in which a backhaul link is disconnected, such a capability may be shared in a process of requesting and responding to relay link establishment.

In a TTR mode, a capability report including a transmit/receive transition gap (TTG), i.e., a minimum receive-to-transmit turnaround gap, and a receive/transmit transition gap (RTG), i.e., a minimum transmit-to-receiver turnaround gap, is additionally transmitted. Further, after a relay link is established, corresponding information may be considered in setting a frame format.

In an STR mode, a capability report including a frequency for a relay link and a frequency for servicing a subordinate MS after establishment of a relay link may be transmitted. When a capability between BSs or a configuration parameter is included with a backhaul link, if a ranging process is complete, it is regarded as a start of relay link establishment of a subordinate BS, and by performing only a configuration step of an operation parameter, relay link establishment may be complete.

When it is requested to set a relay link from a superordinate BS to a subordinate BS, a capability report may be generally usefully used, and additional information TTG/RTG after establishment of the relay link may be included in a process in which the subordinate BS responds to a request of the superordinate BS.

For relay link establishment, according to another exemplary embodiment of the present invention, in addition to a method of setting a relay link of an RS that is defined in the existing conventional art, a relay establishment request message and a response message may be included. A relay establishment request message AAI-MMRS-REQ and a relay establishment response message (AAI-MMRS-RSP) are shown in Tables 1 and 2, respectively.

TABLE 1

| | Size | | Con- |
|---|---|---|---|
| Field | (bits) | Value/Description | dition |
| Request Relay mode | 1 | 0b0: TTR relay mode | Always |
| | | 0b1: STR relay mode | present |
| If (this request is | | | |
| subordinate station | | | |
| initiated request) { | | | |
| If (request relay mode == | | | |
| 0b0) { | | | |
| ARSTTG | 6 | ARSTTG value (μs). | |
| | | It shall be less | |
| | | than 50 μs. | |
| ARSRTG | 6 | ARSRTG value (μs). | |
| | | It shall be less | |
| | | than 50 μs. | |
| } else if (request | | | |
| relay mode == 0b1) { | | | |
| Duplex mode support | 2 | If bit 0 = 1, FDD supports | |
| indication | | If bit 1 = 1, TDD supports | |
| for (i=1; | | N-frequency is the | |
| i<=N-frequency; i++) { | | number of available | |
| | | frequencies to communicate | |
| | | [1..16]. | |
| Carrier frequency | 10 | Indicates the carrier | |
| | | frequency in unit | |
| | | of 100 KHz. | |
| } | | | |
| } | | | |
| } | | | |

TABLE 2

| | Size | | |
|---|---|---|---|
| Field | (bits) | Value/Description | Condition |
| If (the response is | | | Present when |
| transmitted by | | | superordinate HR-BS |
| HR-BS) { | | | responds to the |
| | | | subordinate station |
| | | | initiated request. |
| Response code | 2 | 0b00: in response to the | |
| | | AAI-MMRS-REQ message | |
| | | to accept the request | |
| | | 0b01: in response to the | |
| | | AAI-MMRS-REQ message | |
| | | to allow to transmit | |
| | | subordinate station | |
| | | initiated AAI-ARE-REQ | |
| | | after action time expires | |
| | | 0b10: in response to the | |
| | | AAI-MMRS-REQ message | |
| | | to reject the request 0b11: reserved | |
| If (response | | | |
| code == 0b01) { | | | |
| Action time | 4 | LSBs of the superframe | Always present |
| | | number when the | |
| | | subordinate station | |
| | | transmits AAI-MMRS-REQ | |
| | | message. | |
| } | | | |
| } else { | | | Present when |
| | | | subordinate station |
| | | | responds to the |
| | | | superordinate HR-BS |
| | | | initiated request. |
| If (received | | | // TTR mode |
| request relay | | | |
| mode == 0b0) { | | | |
| ARSTTG | 6 | ARSTTG value (μs). It | Shall be present if |
| | | shall be less than 50 μs. | action code == 0b0 in |
| | | | AAI-MMRS-REQ. |
| ARSRTG | 6 | ARSRTG value (μs). It | Shall be present if |
| | | shall be less than 50 μs. | action code == 0b0 in |
| | | | AAI-MMRS-REQ. |
| } else if | | | // STR mode |
| (received | | | |
| request relay | | | |
| mode == 0b1) { | | | |
| Duplex mode | 2 | If bit 0 = 1, FDD supports | Always present |
| support | | If bit 1 = 1, TDD supports | |
| indication | | | |
| for (i=1; | | N-frequency is the number | |
| i<=N-frequency; | | of available frequencies to | |
| i++) { | | communicate [1..16]. | |
| Carrier | 10 | Indicates the carrier | |
| frequency | | frequency in unit of 100 KHz. | |
| } | | | |
| } | | | |
| } | | | |

In this case, in order to set a relay link, a new MS or an RS is prevented from entering a subordinate BS, and until setting of a relay link is complete, it is notified to the subordinate MS that a service is unavailable in order to set a relay link, and handover to the superordinate BS or another BS is performed to the subordinate MS, or after waiting until relay link establishment is complete, and a relay link is established and then after a BS service is started, communication may be resumed.

Relay establishment may be requested by a subordinate BS or by a superordinate BS. In this case, a situation in which a backhaul link is disconnected may be notified to a subordinate MS in which a service is already being performed, relay link establishment of a superordinate BS may be started, and when a plurality of frequencies exist, the subordinate MS may be started through a frequency in which a service is not performed.

Hereinafter, a case by a request of the subordinate BS at the step of starting relay link establishment (S310) will be described in detail.

When relay link establishment is started by the subordinate BS, a relay establishment request message that is shown in Table 1 includes an RS mode TTR or STR upon establishing a relay link and additional information (RS TTG, RS RTG for TTR, and frequency information for STR) necessary for operating a corresponding mode, and requests relay establishment from the superordinate BS.

In response thereto, the superordinate BS sends an acceptance, a rejection, or a re-request of a request through a relay establishment response message that is shown in Table 2. In this case, the superordinate BS may maintain relay link establishment by immediately accepting upon accepting or may stop relay link establishment by immediately rejecting. Further, upon accepting or rejecting, the superordinate BS may notify a relay link establishment start time point or a re-request together with an action time that is shown in Table 2.

The subordinate BS, having received a rejection including an immediate rejection or an action time, may re-request after an action time in order to resume a request for relay link establishment or may request relay link establishment to another adjacent BS when a relay link may be set with a corresponding BS.

According to another exemplary embodiment of the present invention, when establishment of a relay link of a subordinate BS is requested, if a multi-mode MS or an RS in which a relay link with a superordinate BS is set exists, by releasing a relay link of a corresponding RS or the multi-mode MS, interference of a relay link within a cell may be avoided. In this case, the superordinate BS transmits information of a subordinate MS in which a multi-mode MS or an RS to which a relay link is established services to a subordinate BS through a relay link in a process of establishing a relay link or after a relay link is established. For this purpose, the superordinate BS should store subordinate MS information of a multi-mode MS or a previous RS.

Hereinafter, a case by a request of a superordinate BS at the step of starting relay link establishment (S310) will be described in detail.

When the superordinate BS requests relay link establishment from the subordinate BS, as in a case where the subordinate BS recognizes a situation in which a backhaul link is disconnected through a backhaul network, the superordinate BS requests relay link establishment together with a relay mode TTR or STR to from subordinate BS, as shown in Table 1.

In this case, the subordinate BS includes information necessary for the requested relay mode in frequency information for an RS TTG and an RS RTG for TTR and STR, as shown in Table 2, and responds. In this case, a relay mode that is requested by the subordinate BS may refer to an applicable relay mode that shares BSs using a backhaul network before a backhaul link is disconnected.

The subordinate BS may accept or reject a relay link establishment start by a request of the superordinate BS the same as or similar to a relay link establishment started by a request of the subordinate BS, but when the superordinate BS requests, a response message that the subordinate BS transmits is generally regarded as acceptance. In this case, in order to establish a relay link, the superordinate BS may release a relay link of another RS or a multi-mode MS and start establishment or release while establishing, and requests a subordinate MS of a multi-mode MS or an RS in which a previous relay link is established to perform handover to a BS that newly establishes a relay link. In this case, in order to perform efficient handover, the superordinate BS transmits information of the subordinate MS to the subordinate MS through the relay link in a establishment process of a relay link or after establishing a relay link.

Hereinafter, a message form and a related parameter in IEEE 802.16e and IEEE 802.16j systems will be described in detail.

In the IEEE 802.16e and IEEE 802.16j systems, because various relay links can be established, corresponding information may be included. The corresponding information TLV for MMRS-REQ/RSP may include information that is shown in Table 3.

| Type | Parameter |
|---|---|
| 1 | RS operational mode |
| 2 | Response code |
| 3 | Station Information |
| 4 | RSRTG |
| 5 | RSTTG |
| 6 | Minimum RS forwarding delay in |
| | direct relay zone |
| 7 | Minimum RS forwarding delay |
| 8 | Supported second RS carrier |
| | configurations |
| 9 | Action Time |

An RS operational mode from Table 3 is shown in Table 4.

TABLE 4

| Type | Length | Value | Scope |
|---|---|---|---|
| 1 | 2 | Bit 0: access zone preamble | MM-RS-REQ, |
| | | transmission support | MM-RS-RSP |
| | | Bit 1: MBS Data Synchronization with | |
| | | pre-defined relative transmission | |
| | | time (6.3.23.3) | |
| | | Bit 2: MBS data synchronization | |
| | | with target transmission time (6.3.23.3) | |
| | | Bit 3: cooperative relay support | |
| | | Bit 4: support of a second carrier | |
| | | frequency at RS (see 8.4.4.7.2.2) | |
| | | Bit 5: support STR RS operation (see | |
| | | 8.4.4.7.2.3) | |
| | | Bits 6-9: Maximum number of HARQ | |
| | | channels supported in UL_DCH | |
| | | Bit 10: FDD support in access link | |
| | | Bit 11: H-FDD support in access link | |
| | | Bit 12: FDD support in relay link | |
| | | Bit 13: H-FDD support in relay link | |
| | | Bit 14-15: Reserved | |

A response code is included in an MMRS-RSP message that is transmitted in response to an MMRS-REQ message, and may include information of Table 5 (response code).

TABLE 5

| Type | Length | Value | Scope |
|---|---|---|---|
| 2 | 1 | Bit 0: to accept the request | MM-RS-RSP |
| | | Bit 1: to allow retransmit after action | |
| | | time expires | |
| | | Bit 2: to reject the request | |
| | | Bits 3-7: reserved | |

When a message is scheduled by CID that is managed by an RS from an MS to a BS, station information may include information that is shown in Table 6 (station information).

TABLE 6

| Type | Length | Value | Scope |
|---|---|---|---|
| 3 | 10 | Bits 0-47: SS MAC address | MM-RS-REQ, |
| | | Bits 48-63: SS basic CID | MM-RS-RSP |
| | | Bits 64-79: SS primary management | |
| | | CID | |

Further, when a response code of Table 4 that is included in an MM-RS-RSP message is 0x00, a response code is included in the MM-RS-RSP message.

RSRTG/RSTTG is included, as shown in Table 7, upon requesting or upon approving (when a response code is 0x00) the request regardless of a relay operational mode.

TABLE 7

| Type | Length | Value | Scope |
|---|---|---|---|
| 4 | 10 | RSRTG in μs | MM-RS-REQ, |
| | | | MM-RS-RSP |
| 5 | 10 | RSTTG in μs | MM-RS-REQ, |
| | | | MM-RS-RSP |

In minimum RS forwarding delay in a direct relay zone and a minimum RS forwarding delay scheduling centralizing mode, upon requesting or upon approving (when a response code is 0x00) the request, a response code may be included, as shown in Table 8 (minimum RS forwarding delay TLV).

TABLE 8

| Type | Length | Value | Scope |
|---|---|---|---|
| 6 | variable | The RS downlink process delay is a | MM-RS-REQ, |
| | | compound TLV value that encapsulates | MM-RS-RSP |
| | | TLVs that may be transmitted by | |
| | | HR-MS to act as HR-RS. RS | |
| | | forwarding delay in DL direct relay | |
| | | zone (unit: OFDMA symbols) and/or | |
| | | RS forwarding delay in UL | |
| | | direct relay zone (unit: OFDMA | |
| | | symbols) may be included | |
| | | (see 11.8.19). | |
| 7 | variable | The RS downlink process delay is a | MM-RS-REQ, |
| | | compound TLV value that encapsulates | MM-RS-RSP |
| | | TLVs that may be transmitted by | |
| | | HR-MS to act as HR-RS. RS | |
| | | forwarding delay in DL zone and/or | |
| | | RS forwarding delay in UL zone | |
| | | may be included (see 11.8.20). | |

A supported second RS carrier configuration is information that is included in an STR relay operational mode and may be included, as shown in Table 9, upon requesting or upon approving (when a response code is 0x00) the request.

TABLE 9

| Type | Length | Value | Scope |
|---|---|---|---|
| 8 | variable | The supported second RS carrier | MM-RS-REQ, |
| | | configuration is a compound TLV | MM-RS-RSP |
| | | value that encapsulates TLVs that may | |
| | | be transmitted by HR-MS to act | |
| | | as HR-RS. | |
| | | Predefined second carrier configurations | |
| | | or undefined subbands to be | |
| | | supported by the HR-RS | |
| | | (See 11.8.3.5.24). | |

An action time is a value that is included in an MMRS-RSP message, and when a response code is 0x01 in response to an MMRS-REQ message, the action time is included in an MMRS-RSP message, as shown in Table 10 (action time), and when a corresponding time has expired, the action time may be requested again.

TABLE 10

| Type | Length | Value | Scope |
|---|---|---|---|
| 9 | 1 | Bits 0-3: 4-bit LSBs of frame number | MM-RS-RSP |
| | | to allow the request after action | |
| | | time expires. | |
| | | Bits 4-7: reserved | |

Hereinafter, the step of completing relay link establishment (S320) will be described in detail.

In order to set a relay link, upon establishing the relay link, the superordinate BS transmits a message including setting control information to a subordinate MS for establishing a relay link, as shown in Table 4, according to a relay mode TTR or STR.

In this case, the superordinate BS may generate a preamble through a preamble index and a frequency that are included in the message, and designate a frequency of an access zone to manage a subordinate MS after a relay link is established or designate a relay zone for communication with a superordinate BS.

The subordinate BS may use a preamble index in which the subordinate BS has been previously used before a relay link is established, i.e., before a backhaul link is disconnected. Further, the superordinate BS allocates STID and FID to the subordinate BS and thus determines whether STID and FID are data for the subordinate BS or data for a subordinate MS of the subordinate BS. Alternatively, data may be distinguished through a relay forwarding extended header, which is an extension header for relay to a MAC header.

A superframe number action that is included in a message when transmitting a establishment control message may be used for notifying a relay link start time point.

In order for the superordinate BS and the subordinate BS to set a relay zone for communication, the relay zone may be set by a procedure that is performed when the RS initially enters the BS.

A relay configuration control message is shown in Table 11.

TABLE 11

| | Size | | |
|---|---|---|---|
| Field | (bits) | Value/Description | Conditions |
| If (subordinate RS (including | | | // TTR mode |
| HR-MS acting as RS) is TTR | | | |
| relay mode) { | | | |
| AAI_Relay_zone_AMS_allocation_indicator | 1 | 0b0: The ABS does not | Always present |
| | | allocate resources to the | |
| | | AMS in the AAI DL Relay | |
| | | zone. | |
| | | 0b1: The ABS may allocate | |
| | | resources to the AMS in | |
| | | the AAI DL Relay zone. | |
| MIMO Midamble indication | 1 | 0b0: MIMO midamble is | Always present |
| in | | not transmitted in AAI DL | |
| AAI DL Relay zone | | Relay zone. | |
| | | 0b1: MIMO midamble is | |
| | | transmitted in AAI DL | |
| | | Relay zone. | |
| | | If | |
| | | AAI_Relay_zone_AMS_allocation_indicator == | |
| | | 0b0, | |
| | | this field is set to 0b1. | |
| Superframe Number Action | 4 | LSBs of the superframe | Always present |
| | | number when ARS start | |
| | | ARS operation and apply | |
| | | the PHY operational | |
| | | parameters. | |
| R_IdleTime | 11 | Unit is 0.1 μs | Always present |
| If (ABS allocates resource | | | |
| for periodic ranging in AAI | | | |
| UL Relay zone) { | | | |
| Allocation periodicity of the | 2 | Indicates the periodicity of | Present when ABS |
| S-RCH | | the S-RCH allocation. | allocates resource for |
| | | 0b00: Every frame | periodic ranging in AAI UL |
| | | 0b01: The second frame in | Relay zone. |
| | | every superframe | |
| | | 0b10: The second frame in | |
| | | every 4^{th} superframe, i.e., | |
| | | mod(superframe number, | |
| | | 4) = 0 | |
| | | 0b11: The second frame in | |
| | | every 8^{th} superframe, i.e., | |
| | | mod(superframe number, | |
| | | 8) = 0 | |
| Subframe offset of the | 2 | Indicates the subframe | Present when ABS |
| S-RCH | | offset (OSF) of the S-RCH | allocates resource for |
| | | allocation. The range of | periodic ranging in AAI UL |
| | | values is 0 ≦· OSF ≦· 3. | Relay zone. |
| | | S-RCH is allocated in the | |
| | | (OSF + UAZ) subframe. | |
| Start RP code information of | 4 | Indicates the ks which is | Present when ABS |
| the S-RCH | | the parameter controlling | allocates resource for |
| | | the start root index of the | periodic ranging in AAI |
| | | RP codes rs0. | UL Relay zone. |
| | | rₛ₀ = 6kₛ + 1 | |
| | | The range of values is | |
| | | 0 ≦ kₛ ≦ 15. | |
| NPE | 2 | Indicates the number of | Present when ABS |
| | | periodic code (NPE) | allocates resource for |
| | | according to Table 917. | periodic ranging in AAI |
| | | | UL Relay zone. |
| } | | | |
| If (ABS allocates resource | | | |
| for BR channel in AAI UL | | | |
| Relay zone) { | | | |
| UL BW REQ channel | 2 | Indicates the number and | Present when ABS |
| information | | the location of UL AAI | allocates resource for BR |
| | | subframe where the UL | channel in AAI UL Relay |
| | | BW REQ channels are | zone. |
| | | allocated. | |
| | | 0b00: i-th UL AAI subframe | |
| | | of UL relay zone in the first | |
| | | frame in every superframe | |
| | | 0b01: i-th UL AAI subframe | |
| | | of UL relay zone in the first | |
| | | and second frame in every | |
| | | superframe | |
| | | 0b10: i-th UL AAI subframe | |
| | | of UL relay zone in every | |
| | | frame | |
| | | 0b11: i-th and i + 1-th UL | |
| | | AAI subframes of UL relay | |
| | | zone in every frame | |
| | | Here, i-th is “first” if UL | |
| | | R-RTI = 0 and i-th is | |
| | | “second” if UL R-RTI = Ts. | |
| UL BW REQ channel | 4 | The DRU index for UL BW | Present when ABS |
| allocation | | REQ channel within FPi | allocates resource for BR |
| | | defined by “Frequency | channel in AAI UL Relay |
| | | partition location for UL | zone. |
| | | control channels” in S-SFH | |
| | | SP1. | |
| Bandwidth request backoff | 4 | Initial backoff window size | Present when ABS |
| start | | for contention BRs, | allocates resource for BR |
| | | expressed as a power of 2. | channel in AAI UL Relay |
| | | Values of n range 0-15 | zone. |
| | | (the highest | |
| | | order bits shall be unused | |
| | | and set to 0). | |
| Bandwidth request backoff | 4 | Final backoff window size | Present when ABS |
| end | | for contention BRs, | allocates resource for BR |
| | | expressed as a power of 2. | channel in AAI UL Relay |
| | | Values of n range from | zone. |
| | | 0-15. | |
| } | | | |
| If | | | |
| (AAI_Relay_zone_AMS_allocation_indicator == | | | |
| 0b0){ | | | |
| R_DCASSB0 | 5/4/3 | Indicates the number of | Present when |
| | | subband-based CRUs in | AAI_Relay_zone_AMS_{—} |
| | | FP0 for AAI DL Relay | allocation_indicator == 0b0. |
| | | zone. | |
| | | See 16.6.3.3.2 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_DCASMB0 | 5/4/3 | Indicates the number of | Present when |
| | | miniband-based CRUs in | AAI_Relay_zone_AMS_{—} |
| | | FP0 for AAI DL Relay | allocation_indicator == 0b0. |
| | | zone. | |
| | | See 16.6.3.3.2 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_DCASi | 3/2/1 | Indicates the number of | Present when |
| | | total allocated CRUs, in a | AAI_Relay_zone_AMS_{—} |
| | | unit of a subband, for FPi (i > | allocation_indicator == 0b0. |
| | | 0) for AAI DL Relay zone. | |
| | | See 16.6.3.3.2 | |
| | | Cell-specific resource | |
| | | mapping. | |
| | | For 2048 FFT size, 3 bits | |
| | | For 1024 FFT size, 2 bits | |
| | | For 512 FFT size, 1 bit | |
| R_UCASSB0 | 5/4/3 | Indicates the number of | Present when |
| | | total allocated CRUs, in a | AAI_Relay_zone_AMS_{—} |
| | | unit of a subband, for FPi (i > | allocation_indicator == 0b0. |
| | | 0) for AAI DL Relay zone. | |
| | | See 16.6.3.5.1 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_UCASMB0 | 5/4/3 | Indicates the number of | Present when |
| | | miniband-based CRUs in | AAI_Relay_zone_AMS_{—} |
| | | FP0 for AAI UL Relay | allocation_indicator == 0b0. |
| | | zone. | |
| | | See 16.6.3.5.1 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_UCASi | 3/2/1 | Indicates the number of | Present when |
| | | total allocated CRUs, in a | AAI_Relay_zone_AMS_{—} |
| | | unit of a subband, for FPi (i > | allocation_indicator == 0b0. |
| | | 0) for AAI UL Relay zone. | |
| | | See 16.6.3.5.1 | |
| | | Cell-specific resource | |
| | | mapping. | |
| | | For 2048 FFT size, 3 bits | |
| | | For 1024 FFT size, 2 bits | |
| | | For 512 FFT size, 1 bit | |
| } | | | |
| } | | | // TTR mode only |
| If (subordinate HR-MS is | | | |
| multimode MS acting as | | | |
| HR-RS) { | | | |
| SA-PREAMBLE index | 10 | | Always present |
| MS functionality | 1 | 0b0: MS functionality is | Always present |
| maintenance indication | | maintained after role | |
| | | change. | |
| | | 0b1: MS functionality is not | |
| | | maintained. | |
| Cell bar information | 1 | If Cell bar bit == 0b1, this | Always present |
| | | cell shall not be allowed | |
| | | network entry or reentry. | |
| If (subordinate HR-MS | | | |
| acting as STR relay mode) | | | |
| { | | | |
| Frame configuration index | 6 | The mapping between | Always present |
| | | value of this index and | |
| | | frame configuration is | |
| | | listed in Table 806, Table | |
| | | 807, and Table 808. | |
| FFT size indication | 2 | 0b00: 2048 FFT | Always present |
| | | 0b01: 1024 FFT | |
| | | 0b10: 512 FFT | |
| | | 0b11: reserved | |
| DL carrier frequency for | 10 | Indicates the DL carrier | Present if needed |
| BS and RS (F_{BR}_{_{—}}_{DL}) | | frequency in unit of 100 KHz | |
| | | for MS acting as RS. | |
| | | Used to receive from | |
| | | HR-BS in the DL relay | |
| | | zone. | |
| UL carrier frequency for | 10 | Indicates the UL carrier | Present if needed |
| BS and RS (F_{BR}_{_{—}}_{UL}) | | frequency in unit of 100 KHz | |
| | | for MS acting as RS. | |
| | | Used to transmit to HR-BS | |
| | | in the UL relay zone. | |
| DL carrier frequency for | 10 | Indicates the DL carrier | Shall be present if F_{RM}_{_{—}}_{DL} is |
| RS and MS (F_{RM}_{_{—}}_{DL}) | | frequency in unit of 100 KHz | different from that of |
| | | for MS acting as RS in | HR-BS' DL access zone. |
| | | FDD. If the duplex mode | |
| | | is TDD, this carrier is used | |
| | | for DL/UL. | |
| | | Used to transmit to | |
| | | subordinate HR-MS in the | |
| | | DL in FDD. | |
| | | Used to transmit/receive | |
| | | to/from subordinate | |
| | | HR-MS in TDD. | |
| UL carrier frequency for | 10 | Indicates the UL carrier | Shall be present if F_{RM}_{_{—}}_{UL} is |
| RS and MS (F_{RM}_{_{—}}_{UL}) | | frequency in unit of 100 KHz | different from that of |
| | | for MS acting as RS in | HR-BS' UL access zone. |
| | | FDD. | |
| | | Used to transmit to | |
| | | subordinate HR-MS in the | |
| | | UL in FDD. | |
| Superframe Number | 4 | LSBs of the superframe | Always present |
| Action | | number when HR-RS start | |
| | | RS operation and apply the | |
| | | PHY operational | |
| | | parameters. | |
| } | | | |
| } | | | |
| } | | | |

In IEEE 802.16e and IEEE 802.16j systems, RCD/RS-Config-CMD that is defined in corresponding systems may be reused instead of Table 11. In this case, as described above, the superordinate BS may transmit a relay configuration control message to a subordinate MS and a subordinate BS to configure a relay link.

Hereinafter, the step of managing a relay link (S330) will be described in detail.

Relay link management, i.e., information update, may be performed in a handover process when updating through a configuration control message that is shown in Table 4 or when changing a relay link to another BS.

A process of updating relay link configuration information at the step of managing a relay link (S330) will be described in detail.

After a relay link is established, the subordinate BS or the superordinate BS notifies a configuration information change of the subordinate BS or a configuration information change of the superordinate BS to each other, thereby enabling to perform a continuous service. In this case, in order to prepare a configuration information change, before a configuration information change, the subordinate BS or the superordinate BS previously transmits configuration information change and notifies a time point at which a corresponding configuration information change is applied to a superframe or a frame number action that is included in Table 4. Alternatively, after configuration information is changed, the subordinate BS or the superordinate BS may notify the subordinate MS of a corresponding fact. In this case, the corresponding fact may be notified through a message (RCD, RS-Config-CMD in 802.16Rev3, Table 11) including system information, SFH, and a control channel.

Hereinafter, a relay link change at the step of managing a relay link (S330) will be described in detail.

For movement of a relay mode MS and mitigation of interference with an RS or an MS in which a relay link is formed at a periphery, a corresponding relay link may be moved to another BS. In this case, when changing a relay link frequency of the subordinate BS, or when changing a relay link, the relay link may be changed to a new superordinate BS. In this case, by transmitting information of a subordinate MS while servicing to a new superordinate BS, a continuous service can be performed and a relay link change may be notified to a subordinate MS, and handover to a subordinate MS may be guided or it may be notified to wait to a subordinate MS until a relay link change is complete.

Hereinafter, the step of releasing a relay link (S340) will be described in detail.

The relay link is released through a request of the superordinate BS or a request of the subordinate BS, or when it is necessary to change a superordinate BS of the relay link, the relay link may be released, and the relay link may be established again with a new BS. When the relay link is released, a resource or a connection of a subordinate MS that receives a service of the subordinate BS is deregistered or corresponding connection or resource allocation information is forwarded to an adjacent BS or an RS including a superordinate BS, thereby continuously performing a service.

First, a case of relay link release requested by a superordinate BS at the step of releasing a relay link (S340) will be described.

In order to release a relay link of a subordinate BS in which the relay link is established, the superordinate BS unsolicitely transmits a relay link release response message (Table 6). In response thereto, the subordinate BS to which a relay link is established transmits a relay link release request message (Table 5) and releases the relay link. In this case, when the superordinate BS requests, a relay link release time point together with an action time in Table 6 may be notified, and when a corresponding time has expired, a request message (Table 5) is transmitted as a response.

In this case, while releasing a relay link with a corresponding subordinate BS, by establishing the relay link with another RS or a multi-mode MS, subordinate MS information of the subordinate BS may be transmitted. Alternatively, when a disconnected backhaul link is available again, the subordinate BS may perform the above-described procedure through a backbone network.

Hereinafter, a case of releasing a subordinate BS request relay link at the step of releasing a relay link (S340) will be described.

When the subordinate BS needs to release a relay link like when a disconnected backhaul link is available again, the subordinate BS transmits a request message (Table 5). In response thereto, the superordinate BS responds regarding acceptance and an action time through a response message (Table 6). When the superordinate BS accepts, the superordinate BS may deregister by immediate acceptance or release after an action time in order to establish a relay link with another RS or an MS. Further, the superordinate BS may reject or allow a re-request including an action time. When the subordinate BS receives a rejection to a response message or receives a response including an action time, the subordinate BS may maintain a relay link, or when an action time has expired, the subordinate BS may re-request and release the relay link. Alternatively, when a disconnected backhaul link is available again, the subordinate BS may perform the above-described procedure through a backbone network.

Hereinafter, a case of releasing a relay link due to movement of an MS at the step of releasing a relay link (S340) will be described.

In the MS, mobility is generally considered. As a multi-mode MS to which a relay link is set moves, when interference with another RS or an MS to which a relay link is set occurs, the relay link should be released. Further, in order to continuously perform a service of a subordinate MS of a subordinate BS in which a relay link has been established, the superordinate BS requests relay link established to another RS or a multi-mode MS within the BS or a relay link may be established by the RS or the multi-mode MS instead of the subordinate BS.

In addition, when requesting relay link release, the following information is included and a reason of requesting release may be notified. First, corresponding information indicates when no subordinate MS exists, when a battery is approaching a predefined threshold level, when an interference level is overwhelming, and when normal power-off is initiated.

Table 12 illustrates a relay link release request message

(AAI-MMRL-REQ), and Table 13 illustrates a relay link release response message (AAI-MMRL-RSP).

TABLE 12

| | Size | | |
|---|---|---|---|
| Field | (bits) | Value/Description | Condition |
| Release_Request_Code | 2 | Used to indicate the | Always |
| | | purpose of this message. | present |
| | | 0b00: multimode release | |
| | | 0b01: response for the | |
| | | unsolicited AAI-MMRL- | |
| | | RSP message by the | |
| | | HR-BS | |
| | | 0b10: reject the unsolicited | |
| | | AAI-MMRL-RSP message | |
| | | by the HR-BS. This code is | |
| | | applicable only when UL | |
| | | data is pending | |
| | | transmission. | |
| | | 0b11: reserved | |

TABLE 13

| | Size | | |
|---|---|---|---|
| Field | (bits) | Value/Description | Condition |
| Action code | 2 | Used to indicate the purpose of this | Always |
| | | message. | present |
| | | 0b00: HR-MS shall immediately | |
| | | terminate multimode service and | |
| | | return to its original HR-MS mode. | |
| | | 0b01: HR-MS shall terminate | |
| | | multimode service and return | |
| | | its original HR-MS mode when | |
| | | the action time expires. | |
| | | 0b10: In response to an AAI-MMRL- | |
| | | REQ message to allow HR-MS to | |
| | | transmit MS-initiated request after | |
| | | action time expires. | |
| | | 0b11: In response to an AAI-MMRL- | |
| | | REQ message to reject the request | |
| | | of HR-MS. | |
| If (action | | | |
| code == | | | |
| 0b01 or | | | |
| 0b10) { | | | |
| Action time | 4 | LSBs of the superframe number when | Always |
| | | HR-RS starts releasing the multimode | present |
| | | or transmit AAI-MMRL-REQ | |
| | | message. | |
| } | | | |

According to the present exemplary embodiment, in a communication system, when a backhaul link of a BS is damaged, the BS establishes a relay link with an adjacent BS and performs a role of an RS, thereby performing a smooth communication operation.

Hereinafter, a method of relaying in an MS according to another exemplary embodiment of the present invention will be described.

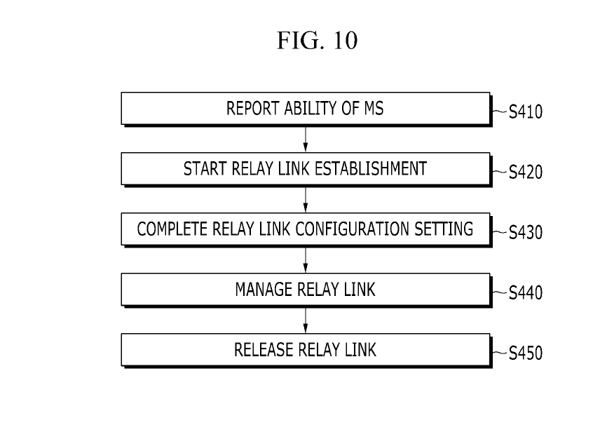

FIG. 10 is a flowchart illustrating a method of relaying in an MS according to an exemplary embodiment of the present invention.

Relay link management for performing a role of an RS of the MS includes a capability report of an MS (may include a start of relay link establishment), relay link establishment start (MS-initiated, BS/RS-initiated), relay link establishment completion, relay link management (may include information update of a set link and a relay link change), and relay link release.

First, the step of reporting a capability of an MS (S410) will be described in detail.

In the present exemplary embodiment, a subordinate MS of the BS is described, and an exemplary embodiment of the present invention can be applied to a subordinate MS of an RS instead of the BS.

In a multi-mode operation, in order to request relay link establishing to an MS having a capability of a multi-mode operation of a subordinate MS of the BS, the BS determines whether the MS performs a role of an RS and should manage a corresponding MS. For this purpose, in a process of performing initial access, the MS may transmit a capability report message, as shown in Table 1.

TABLE 14

| | Size | | |
|---|---|---|---|
| Field | (bits) | Value/Description | Condition |
| Multimode | 2 | If bit 0 = 1, TTR mode | If the MS is capable of |
| capability | | supports. | supporting relay mode. |
| | | If bit 1 = 1, STR mode | |
| | | supports. | |

Further, in a process in which the MS performs handover to a target BS, a process in which a serving BS notifies capability of a relay role of a target BS or a process in which a corresponding MS should report a capability to a target BS upon performing handover may be included within a handover action.

When notifying a relay role capability, if a relay role can be performed, a relay mode, for example, a time-division transmit and receive (TTR) mode or a simultaneous transmit and receive (STR) mode, is included and notified, or in a TTR mode, a transmit/receive transition gap (TTG), for example, a minimum receive-to-transmit turnaround gap and a receive/transmit transition gap (RTG), for example, a minimum transmit-to-receiver turnaround gap (RTG), are additionally included and transmitted, and after a relay link is set, corresponding information may be considered in setting a frame format. In an STR mode, a frequency for a relay link and a frequency for servicing a subordinate MS upon performing a relay role may be included and transmitted.

A capability report may be generally useful when the BS requests relay link establishment to the MS, and additional information TTG or RTG in a relay role performing capability may be included in a process in which the MS responds when the BS requests.

Hereinafter, the step of starting relay link establishment (S420) will be described.

The step of starting relay link establishment (S420) is requested by an MS or a BS, and in this case, a used relay establishment request message may be the same as that of Table 15, and a relay establishment response message may be the same as that of Table 16.

Hereinafter, a method of starting MS request relay link establishment at the step of starting relay link establishment (S420) will be described in detail.

When relay link establishment is started by the MS, an RS mode TTR or STR to be established and additional information necessary for operation of a corresponding mode, for example, frequency information for an RS TTG and RSs RTG and STR, is included in an AAI-MMRS-REQ, as shown in Table 1, and is requested from the BS.

In response thereto, the BS may respond as acceptance, rejection, or re-request of a request through an AAI-MMRS-RSP, as shown in Table 16. Upon accepting, by immediately accepting, relay link establishment is continuously performed, or by immediately rejecting, relay link establishment is stopped, or upon accepting or rejecting, a relay link establishment start time point or re-request including an action time that is shown in Table 16 may be notified.

When an MS, having received a rejection including an immediate rejection or an action time, can re-request after an action time in order to resume a request for relay link establishment or can perform handover to an adjacent BS, after handover to a corresponding BS is performed, the MS may request relay link establishment.

Further, when the MS requests, if a multi-mode MS or an RS in which a relay link with a BS has already been set exists, by deregistering a corresponding RS or a relay link of a multi-mode MS, interference of a relay link within a cell may be avoided. In this case, the BS may transmit information of an MS in which a multi-mode MS or an RS to which a relay link is set services to an MS to generate a relay link. For this purpose, the BS should store subordinate MS information of a multi-mode MS or a previous RS.

A method of starting BS request relay link establishment at the step of starting relay link establishment (S420) will be described in detail.

When requesting relay link establishment from the MS by the BS, the BS requests relay link establishment including a relay mode from the MS, as shown in Table 2.

TABLE 15

| | Size | | |
|---|---|---|---|
| Field | (bits) | Value/Description | Condition |
| Request Relay mode | 1 | 0b0: TTR relay mode | Always |
| | | 0b1: STR relay mode | present |
| If (this request is subordinate | | | |
| station initiated request) { | | | |
| If (request relay mode == | | | |
| 0b0) { | | | |
| ARSTTG | 6 | ARSTTG value (μs). It shall be less | |
| | | than 50 μs. | |
| ARSRTG | 6 | ARSRTG value (μs). It shall be less | |
| | | than 50 μs. | |
| } else if (request relay mode == | | | |
| 0b1) { | | | |
| Duplex mode support | 2 | If bit 0 = 1, FDD supports | |
| indication | | If bit 1 = 1, TDD supports | |
| for (i=1; i<=N-frequency; | | N-frequency is the number of | |
| i++) { | | available frequencies to communicate | |
| | | [1 . . . 16]. | |
| Carrier frequency | 10 | Indicates the carrier frequency in unit | |
| | | of 100 KHz. | |
| } | | | |
| } | | | |
| } | | | |

In this case, the MS includes information necessary for a requested relay mode in frequency information for an RS TTG and RSs RTG and STR, as shown in Table 16, and responds. Even in this case, the MS may accept or reject like an MS request relay link establishment start, but generally, when the BS requests, the MS regards a response message as acceptance.

TABLE 16

| | Size | | |
|---|---|---|---|
| Field | (bits) | Value/Description | Condition |
| If (the response is | | | Present when |
| transmitted by | | | superordinate HR-BS |
| HR-BS) { | | | responds the |
| | | | subordinate station |
| | | | initiated request. |
| response code | 2 | 0b00: in response to the | |
| | | AAI-MMRS-REQ message | |
| | | to accept the request | |
| | | 0b01: in response to the | |
| | | AAI-MMRS-REQ message | |
| | | to allow to transmit | |
| | | subordinate station | |
| | | initiated AAI-ARE-REQ | |
| | | after action time expires | |
| | | 0b10: in response to the | |
| | | AAI-MMRS-REQ message | |
| | | to reject the request | |
| | | 0b11: reserved | |
| If (response | | | |
| code == 0b01) { | | | |
| Action time | 4 | LSBs of the superframe | Always present |
| | | number when the | |
| | | subordinate station | |
| | | transmits AAI-MMRS-REQ | |
| | | message. | |
| } | | | |
| } else { | | | Present when |
| | | | subordinate station |
| | | | responds to the |
| | | | superordinate HR-BS |
| | | | initiated request. |
| If (received | | | // TTR mode |
| request relay | | | |
| mode == 0b0) { | | | |
| ARSTTG | 6 | ARSTTG value (μs). It | Shall be present if |
| | | shall be less than 50 μs. | action code == 0b0 in |
| | | | AAI-MMRS-REQ. |
| ARSRTG | 6 | ARSRTG value (μs). It | Shall be present if |
| | | shall be less than 50 μs. | action code == 0b0 in |
| | | | AAI-MMRS-REQ. |
| } else if | | | // STR mode |
| (received | | | |
| request relay | | | |
| mode == 0b1) { | | | |
| Duplex mode | 2 | If bit 0 = 1, FDD supports | Always present |
| support | | If bit 1 = 1, TDD supports | |
| indication | | | |
| for (i=1; | | N-frequency is the number | |
| i<=N-frequency; | | of available frequencies to | |
| i++) { | | communicate [1 . . . 16]. | |
| Carrier | 10 | Indicates the carrier | |
| frequency | | frequency in unit of 100 KHz. | |
| } | | | |
| } | | | |
| } | | | |

In this case, in order to set a relay link, a BS may deregister a relay link of another RS or a multi-mode MS and start establishment or release of a relay link while establishing, and may request a subordinate MS of a multi-mode MS or an RS in which a previous relay link is set to perform handover from an MS that newly establishes a relay link. In this case, in order to perform efficient handover, information of a subordinate MS may be transmitted to an MS that newly establishes a relay link through a relay link in a process of configuration a relay link or after a relay link is established.

Hereinafter, the step of completing relay link configuration (S430) will be described.

In order to configure a relay link, upon establishing a relay link, the BS transmits a message including configuration control information for configuration a relay link to the MS, as shown in Table 17, according to a relay mode TTR or STR.

TABLE 17

| | Size | | |
|---|---|---|---|
| Field | (bits) | Value/Description | Conditions |
| If (subordinate RS (including | | | // TTR mode |
| HR-MS acting as RS) is TTR | | | |
| relay mode) { | | | |
| AAI_Relay_zone_AMS_allocation_indicator | 1 | 0b0: The ABS does not | Always present |
| | | allocate resources to the | |
| | | AMS in the AAI DL Relay | |
| | | zone. | |
| | | 0b1: The ABS may allocate | |
| | | resources to the AMS in | |
| | | the AAI DL Relay zone. | |
| MIMO midamble indication | 1 | 0b0: MIMO midamble is | Always present |
| in | | not transmitted in AAI DL | |
| AAI DL Relay zone | | Relay zone. | |
| | | 0b1: MIMO midamble is | |
| | | transmitted in AAI DL | |
| | | Relay zone. | |
| | | If | |
| | | AAI_Relay_zone_AMS_allocation_indicator == | |
| | | 0b0, | |
| | | this field is set to 0b1. | |
| Superframe Number Action | 4 | LSBs of the superframe | Always present |
| | | number when ARS start | |
| | | ARS operation and apply | |
| | | the PHY operational | |
| | | parameters. | |
| R_IdleTime | 11 | Unit is 0.1 μs | Always present |
| If (ABS allocates resource | | | |
| for periodic ranging in AAI | | | |
| UL Relay zone) { | | | |
| Allocation periodicity of the | 2 | Indicates the periodicity of | Present when ABS |
| S-RCH | | the S-RCH allocation. | allocates resource for |
| | | 0b00: Every frame | periodic ranging in AAI UL |
| | | 0b01: The second frame in | Relay zone |
| | | every superframe | |
| | | 0b10: The second frame in | |
| | | every 4^{th} superframe, i.e., | |
| | | mod(superframe number, | |
| | | 4) = 0 | |
| | | 0b11: The second frame in | |
| | | every 8^{th} superframe, i.e., | |
| | | mod(superframe number, | |
| | | 8) = 0 | |
| Subframe offset of the | 2 | Indicates the subframe | Present when ABS |
| S-RCH | | offset (OSF) of the S-RCH | allocates resource for |
| | | allocation. The range of | periodic ranging in AAI UL |
| | | values is 0 ≦· OSF ≦· 3. | Relay zone. |
| | | S-RCH is allocated in the | |
| | | (OSF + UAZ) subframe. | |
| Start RP code information of | 4 | Indicates the ks which is | Present when ABS |
| the S-RCH | | the parameter controlling | allocates resource for |
| | | the start root index of the | periodic ranging in AAI |
| | | RP codes rs0. | UL Relay zone |
| | | rₛ₀ = 6kₛ + 1 | |
| | | The range of values is | |
| | | 0 ≦ kₛ ≦ 15. | |
| NPE | 2 | Indicates the number of | Present when ABS |
| | | periodic codes (NPE) | allocates resource for |
| | | according to the Table 917. | periodic ranging in AAI |
| | | | UL Relay zone |
| } | | | |
| If (ABS allocates resource | | | |
| for BR channel in AAI UL | | | |
| Relay zone) { | | | |
| UL BW REQ channel | 2 | Indicates the number and | Present when ABS |
| information | | the location of UL AAI | allocates resource for BR |
| | | subframes where the UL | channel in AAI UL Relay |
| | | BW REQ channels are | zone. |
| | | allocated. | |
| | | 0b00: i-th UL AAI subframe | |
| | | of UL relay zone in the first | |
| | | frame in every superframe | |
| | | 0b01: i-th UL AAI subframe | |
| | | of UL relay zone in the first | |
| | | and second frame in every | |
| | | superframe | |
| | | 0b10: i-th UL AAI subframe | |
| | | of UL relay zone in every | |
| | | frame | |
| | | 0b11: i-th and i + 1-th UL | |
| | | AAI subframes of UL relay | |
| | | zone in every frame | |
| | | Where i-th is “first” if UL | |
| | | R-RTI = 0 and i-th is | |
| | | “second” if UL R-RTI = Ts. | |
| UL BW REQ channel | 4 | The DRU index for UL BW | Present when ABS |
| allocation | | REQ channel within FPi | allocates resource for BR |
| | | defined by “Frequency | channel in AAI UL Relay |
| | | partition location for UL | zone |
| | | control channels” in S-SFH | |
| | | SP1. | |
| Bandwidth request backoff | 4 | Initial backoff window size | Present when ABS |
| start | | for contention BRs, | allocates resource for BR |
| | | expressed as a power of 2. | channel in AAI UL Relay |
| | | Values of n range 0-15 | zone. |
| | | (the highest | |
| | | order bits shall be unused | |
| | | and set to 0). | |
| Bandwidth request backoff | 4 | Final backoff window size | Present when ABS |
| end | | for contention BRs, | allocates resource for BR |
| | | expressed as a power of 2. | channel in AAI UL Relay |
| | | Values of n range from | zone. |
| | | 0-15. | |
| } | | | |
| If | | | |
| (AAI_Relay_zone_AMS_allocation_indicator == | | | |
| 0b0){ | | | |
| R_DCASSB0 | 5/4/3 | Indicates the number of | Present when |
| | | subband-based CRUs in | AAI_Relay_zone_AMS_{—} |
| | | FP0 for AAI DL Relay | allocation_indicator == 0b0. |
| | | zone. | |
| | | See 16.6.3.3.2 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_DCASMB0 | 5/4/3 | Indicates the number of | Present when |
| | | miniband-based CRUs in | AAI_Relay_zone_AMS_{—} |
| | | FP0 for AAI DL Relay | allocation_indicator == 0b0. |
| | | zone. | |
| | | See 16.6.3.3.2 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_DCASi | 3/2/1 | Indicates the number of | Present when |
| | | total allocated CRUs, in a | AAI_Relay_zone_AMS_{—} |
| | | unit of a subband, for FPi (i > | allocation_indicator == 0b0. |
| | | 0) for AAI DL Relay zone. | |
| | | See 16.6.3.3.2 | |
| | | Cell-specific resource | |
| | | mapping. | |
| | | For 2048 FFT size, 3 bits | |
| | | For 1024 FFT size, 2 bits | |
| | | For 512 FFT size, 1 bit | |
| R_UCASSB0 | 5/4/3 | Indicates the number of | Present when |
| | | total allocated CRUs, in a | AAI_Relay_zone_AMS_{—} |
| | | unit of a subband, for FPi (i > | allocation_indicator == 0b0. |
| | | 0) for AAI DL Relay zone. | |
| | | See 16.6.3.5.1 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_UCASMB0 | 5/4/3 | Indicates the number of | Present when |
| | | miniband-based CRUs in | AAI_Relay_zone_AMS_{—} |
| | | FP0 for AAI UL Relay | allocation_indicator == 0b0. |
| | | zone. | |
| | | See 16.6.3.5.1 | |
| | | Cell-specific resource | |
| | | mapping. | |
| | | For 2048 FFT size, 5 bits | |
| | | For 1024 FFT size, 4 bits | |
| | | For 512 FFT size, 3 bits | |
| R_UCASi | 3/2/1 | Indicates the number of | Present when |
| | | total allocated CRUs, in a | AAI_Relay_zone_AMS_{—} |
| | | unit of a subband, for FPi (i > | allocation_indicator == 0b0. |
| | | 0) for AAI UL Relay zone. | |
| | | See 16.6.3.5.1 | |
| | | Cell-specific resource | |
| | | mapping. | |
| | | For 2048 FFT size, 3 bits | |
| | | For 1024 FFT size, 2 bits | |
| | | For 512 FFT size, 1 bit | |
| } | | | |
| } | | | // TTR mode only |
| If (subordinate HR-MS is | | | |
| multimode MS acting as | | | |
| HR-RS) { | | | |
| SA-PREAMBLE index | 10 | | Always present |
| MS functionality | 1 | 0b0: MS functionality is | Always present |
| maintenance indication | | maintained after role | |
| | | change | |
| | | 0b1: MS functionality is not | |
| | | maintained | |
| Cell bar information | 1 | If Cell bar bit == 0b1, this | Always present |
| | | cell shall not be allowed | |
| | | network entry or reentry | |
| If (subordinate HR-MS | | | |
| acting as STR relay mode) | | | |
| { | | | |
| Frame configuration index | 6 | The mapping between | Always present |
| | | value of this index and | |
| | | frame configuration is | |
| | | listed in Table 806, Table | |
| | | 807, and Table 808. | |
| FFT size indication | 2 | 0b00: 2048 FFT | Always present |
| | | 0b01: 1024 FFT | |
| | | 0b10: 512 FFT | |
| | | 0b11: reserved | |
| DL carrier frequency for | 10 | Indicates the DL carrier | Present if needed |
| BS and RS (F_{BR}_{_{—}}_{DL}) | | frequency in unit of 100 KHz | |
| | | for MS acting as RS. | |
| | | Used to receive from | |
| | | HR-BS in the DL relay | |
| | | zone. | |
| UL carrier frequency for | 10 | Indicates the UL carrier | Present if needed |
| BS and RS (F_{BR}_{_{—}}_{UL}) | | frequency in unit of 100 KHz | |
| | | for MS acting as RS. | |
| | | Used to transmit to HR-BS | |
| | | in the UL relay zone. | |
| DL carrier frequency for | 10 | Indicates the DL carrier | Shall be present if F_{RM}_{_{—}}_{DL} is |
| RS and MS (F_{RM}_{_{—}}_{DL}) | | frequency in unit of 100 KHz | different from that of |
| | | for MS acting as RS in | HR-BS' DL access zone. |
| | | FDD. If the duplex mode | |
| | | is TDD, this carrier is used | |
| | | for DL/UL. | |
| | | Used to transmit to | |
| | | subordinate HR-MS in the | |
| | | DL in FDD. | |
| | | Used to transmit/receive | |
| | | to/from subordinate | |
| | | HR-MS in TDD. | |
| UL carrier frequency for | 10 | Indicates the UL carrier | Shall be present if F_{RM}_{_{—}}_{UL} is |
| RS and MS (F_{RM}_{_{—}}_{UL}) | | frequency in unit of 100 KHz | different from that of |
| | | for MS acting as RS in | HR-BS' UL access zone. |
| | | FDD. | |
| | | Used to transmit to | |
| | | subordinate HR-MS in the | |
| | | UL in FDD. | |
| Superframe Number | 4 | LSBs of the superframe | Always present |
| Action | | number when HR-RS start | |
| | | RS operation and apply the | |
| | | PHY operational | |
| | | parameters. | |
| } | | | |
| } | | | |
| } | | | |

In this case, a preamble is generated through a preamble index and a frequency that are included in a message, and after a relay link is set, a frequency of an access zone to manage a subordinate MS may be designated or a relay zone for communication with a BS may be designated.

Further, the message includes information about whether a multi-mode MS operates an RS mode through a relay link while maintaining a function of the MS after a relay link is set. When an MS function should be maintained, the BS performs a service for maintaining an MS function through a relay zone with a corresponding relay mode MS.

Because a relay mode MS that performs an MS function performs a service with a BS through a relay zone, it is necessary to determine whether data are for relay or for a relay mode MS.

In this case, by newly allocating FID for relaying or by additionally allocating STID and FID for new relay while maintaining STID and FID that are allocated to the MS, data may be distinguished. Alternatively, data may be distinguished through a relay forwarding extended header, which is an extension header for relay to a MAC header.

A superframe number action that is included in a message when transmitting a configuration control message may be used for notifying a relay link start time point. In this case, because a control message that is transmitted before start of a relay link is transmitted before a relay zone is generated, the control message is transmitted from a BS to a downlink frame zone, and after a relay link is set, when transmission of a control message is necessary, the control message is transmitted through a relay zone.

Hereinafter, the step of managing a relay link (S440) will be described.

Relay link management is the step of updating information and may be updated through a configuration control message or may be performed in a handover process when changing a relay link to another BS, as shown in Table 17.

A process of updating relay link configuration information at the step of managing a relay link (S440) will be described.

After a relay link is set, a change of configuration information of a relay mode MS or a configuration information change of a BS is notified and thus configuration information change contents for servicing a relay link and a subordinate MS are notified and a continuous service can be thus performed. In this case, in order to prepare a configuration information change, the configuration information change may be previously transmitted before a configuration information change, and a time point at which a corresponding configuration information change is applied to a superframe number action that is included in Table 17 may be notified. Alternatively, after configuration information is changed, a corresponding fact may be notified to a subordinate MS. In this case, a corresponding fact may be notified through a message including system information, SFH, or a control channel.

A process of changing a relay link at the step of managing a relay link (S440) will be described.

For movement of a relay mode MS or for mitigation of interference with an MS or an RS in which a relay link is formed at a periphery, movement of a corresponding relay link to another BS, i.e., handover of a relay mode MS may be performed.

In this case, a frequency of a relay link of an MS is changed, or upon performing handover, a relay link may be changed to a target BS. In this case, by transmitting information of a subordinate MS while performing a service to a target BS, a continuous service may be performed, a relay link change may be notified to a subordinate MS, and handover may be guided to a subordinate MS, or it may be notified to await to a subordinate MS until a relay link change is complete.

Hereinafter, the step of releasing a relay link (S450) will be described in detail.

The relay link may be released through a request of a BS or through a request of an MS. Further, when a relay link with a BS cannot be continuously maintained due to movement, i.e., handover of an MS, the relay link is deregistered, and a relay link with a new BS may be set again. In this case, the relay link may be changed to a target BS. When the relay link is released, a connection or a resource of a subordinate MS that receives a service of a relay mode MS is deregistered or corresponding connection or resource allocation information is forwarded to an adjacent BS or an RS, and thus a service can be continuously performed.

Hereinafter, relay link release by a request of a BS at the step of releasing a relay link (S450) will be described.

In order to release a relay link of a multi-mode MS to which a relay link is established, the BS unsolicitely transmits an AAI-MMRL-REQ, as shown in Table 18.

TABLE 18

| | Size | | |
|---|---|---|---|
| Field | (bits) | Value/Description | Condition |
| Release_Request_Code | 2 | Used to indicate the | Always |
| | | purpose of this message. | present |
| | | 0b00: multimode release | |
| | | 0b01: response for | |
| | | the unsolicited | |
| | | AAI-MMRL-RSP | |
| | | message by the HR-BS | |
| | | 0b10: reject for | |
| | | the unsolicited | |
| | | AAI-MMRL-RSP | |
| | | message by the | |
| | | HR-BS. This code is | |
| | | applicable only when | |
| | | UL data is pending | |
| | | transmission. | |
| | | 0b11: reserved | |

In response thereto, an MS to which a relay link is set transmits an AAI-MMRL-RSP and releases the relay link, as shown in Table 19. In this case, when the BS requests, the MS may notify the BS of a relay link release time point together with an action time that is included in Table 6, and when a corresponding time has expired, the MS transmits a request message (Table 18) as a response. In this case, while a relay link with a corresponding MS is released, the BS establishes a relay link with another RS or a multi-mode MS, and may transmit subordinate MS information of an MS that releases a relay link to a corresponding RS or the multi-mode MS.

TABLE 19

| | Size | | |
|---|---|---|---|
| Field | (bits) | Value/Description | Condition |
| Action | 2 | Used to indicate the purpose of this | Always |
| code | | message. | present |
| | | 0b00: HR-MS shall immediately terminate | |
| | | multimode service and return to its | |
| | | original HR-MS mode. | |
| | | 0b01: HR-MS shall terminate multimode | |
| | | service and return to its original HR-MS | |
| | | mode when the action time expires. | |
| | | 0b10: In response to an AAI-MMRL-REQ | |
| | | message to allow HR-MS to transmit | |
| | | MS-initiated request after the action time | |
| | | expires. | |
| | | 0b11: In response to an AAI-MMRL-REQ | |
| | | message to reject the request of HR-MS. | |
| If (action | | | |
| code == | | | |
| 0b01 or | | | |
| 0b10) { | | | |
| Action | 4 | LSBs of the superframe number when | Always |
| time | | HR-RS starts releasing the multimode or | present |
| | | transmit AAI-MMRL-REQ message. | |
| } | | | |

Release of an MS request relay link at the step of releasing a relay link (S450) will be described.

When releasing a relay link due to a power problem or movement of an MS, the MS transmits an AAI-MMRL-REQ to a BS, as shown in Table 5. In response thereto, the BS responds with the AAI-MMRL-REQ including acceptance or not and an action time, as shown in Table 19.

When the BS accepts upon responding, the BS may deregister by immediately accepting, deregister after an action time in order to set a relay link with another RS or MS, reject, or allow a re-request including an action time. When the MS receives a rejection in a response message or receives a response including an action time, the MS may maintain a relay link or release a relay link by a re-request when an action time has expired.

Release of a relay link due to movement of an MS at the step of releasing a relay link (S450) will be described.

In the MS, mobility is generally considered. When a multi-mode MS to which a relay link is set experiences interference with an MS or another RS to which a relay link is set by movement or moves to an adjacent cell, the multi-mode MS should release the relay link. Alternatively, when a multi-mode MS moves to an adjacent cell, the multi-mode MS may maintain a relay link with a corresponding BS. When the multi-mode MS moves to an adjacent cell, the multi-mode MS generally performs handover. Therefore, the multi-mode MS may perform a process of releasing a relay link while performing handover or include relay link release related information in a handover message.

Further, in order to continuously perform a service of a subordinate MS of an MS to which a relay link is set, the BS may request setting of a relay link to a multi-mode MS within the BS or a relay link may be set by a multi-mode MS. When it is more useful to set a relay link with an adjacent BS than a relay link that is set with a present BS, an MS in which handover is performed or in which a moving relay link is set may continuously maintain a relay link with the adjacent BS and convert a BS to which a relay link is set. In this case, as a serving BS transmits relay link related information to an adjacent BS, a relay link that is set with the adjacent BS may be maintained or the adjacent BS may transmit relay link configuration information.

According to the present exemplary embodiment, in a communication system, an MS performs a role of a BS or an RS, thereby smoothly performing a multi-operational mode.

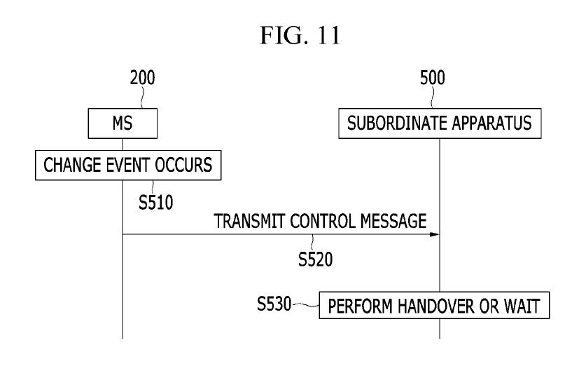

When a backhaul link is damaged, the MS may operate as a BS or an RS, and such an MS is referred to as a multi-mode MS. Hereinafter, a method of transmitting in an MS will be described in detail with reference to FIG. 11.

FIG. 11 is a flowchart illustrating a method of transmitting in an MS according to an exemplary embodiment of the present invention.

A change event occurs in the MS 200 (S510). Here, the change event indicates when a backhaul link is in an unavailable (disconnection, collapse) state or when a backhaul link is recovered, when resetting a backhaul link due to periodic transmission or change of configuration information of a physical layer PHY or a MAC layer in a multi-mode operation state, when converting to a multi-mode or when converting from a multi-mode to an original mode, when it is necessary to notify power down or reduction or power on or increasing, and when frequency allocation (FA) is changed.

In such a case, the MS 200 transmits a control message to a subordinate apparatus, for example, another MS, a BS, or an RS (S520). In this case, the control message is transmitted through a downward control channel or with another previously defined method such as broadcast, multicast, or unicast.

In the present exemplary embodiment, it is described that an MS transmits a control message, but when a necessary event occurs, an infrastructure station other than an MS may transmit a control message to a subordinate apparatus.

Such a control message (MM-ADV) may be transmitted in a form including information that is illustrated in Table 20 or 21. Table 20 is formed based on an IEEE 802.16.1 system, and Table 21 is formed based on an IEEE 802.16Rev3 system.

TABLE 20

| | Size | | |
|---|---|---|---|
| Field | (bits) | Value/Description | Condition |
| Action Type | 3 | Used to indicate the purpose of | Mandatory |
| | | this message. | |
| | | 0b000: Reconfiguration of | |
| | | HR-BS/RS including multimode | |
| | | BS/RS | |
| | | 0b001: Restart of HR-BS/RS | |
| | | including multimode BS/RS | |
| | | 0b010: Power down (including | |
| | | FA down) of HR-BS/RS | |
| | | including multimode BS/RS | |
| | | 0b011: Power reduction of | |
| | | HR-BS/RS including multimode | |
| | | BS/RS | |
| | | 0b100: Backhaul link down of | |
| | | HR-BS | |
| | | 0b101: Backhaul link up of | |
| | | HR-BS | |
| | | 0b110: FA change of HR-BS/RS | |
| | | including multimode BS/RS | |
| | | 0b111: Multimode service end | |
| | | of HR-MS | |
| If (Action Type | | | // |
| == 0b000) { | | | reconfigu- |
| | | | ration |
| New IDcell | 10 | New IDcell that the ABS will | Optional |
| | | use after the reconfiguration | |
| | | process. | |
| Frame | 6 | New mapping between value of | Optional |
| configuration | | this index and frame | |
| index | | configuration is listed in Table | |
| | | 806, Table 807, and Table 808. | |
| Unavailable | 8 | Start of unavailable time in unit | Mandatory |
| Start Time | | of frame. | |
| (UST) | | | |
| Unavailable | 8 | Interval of unavailable time in | Mandatory |
| Time Interval | | unit of superframe. | |
| (UTI) | | | |
| } else if (Action | | | // restart |
| Type == 0b001) | | | |
| { | | | |
| Unavailable | 8 | Start of unavailable time in unit | Mandatory |
| Start Time | | of frame. | |
| (UST) | | | |
| Unavailable | 8 | Interval of unavailable time in | Mandatory |
| Time Interval | | unit of superframe. | |
| (UTI) | | | |
| } else if (Action | | | // power |
| Type == 0b010) | | | down |
| { | | | |
| Time of Power | 8 | Expected time when the | Mandatory |
| Down | | HR-BS will be powered down | |
| | | in units of frame. | |
| Expected | 8 | Expected uptime of BS in units | Optional |
| uptime of BS | | of superframe. | |
| } else if (Action | | | // power |
| Type == 0b011) | | | reduction |
| { | | | |
| Tx Power | 10 | dB value of Tx power reduction. | Mandatory |
| Reduction | | | |
| Expected time | 8 | Expected resource adjustment | |
| of power | | time in units of frame. | |
| reduction | | | |
| } else if (Action | | | // backhaul |
| Type == 0b100) | | | link down |
| { | | | |
| Time of | 8 | Expected time when the | Optional |
| backhaul link | | backhaul link will be down in | |
| down | | units of superframe. | |
| Expected time | 8 | Expected time in unit of LSB of | Optional |
| of backhaul | | superframe when backhaul | |
| link available | | link will be available of HR-BS | |
| | | either itself or via neighbor | |
| | | HR-BS. | |
| } else if (Action | | | // backhaul |
| Type == 0b101) | | | link up |
| { | | | |
| Expected time | 8 | Expected time in unit of LSB of | Optional |
| of backhaul | | superframe when the HR-BS | |
| link up | | restarts service without any help | |
| | | of neighbor BS using relay link | |
| | | but the HR-BS' backhaul link. | |
| } else if (Action | | | // FA change |
| Type == | | | |
| 0b110){ | | | |
| FA index | 8 | FA index | Mandatory |
| Expected | 8 | Expected current FA downtime | |
| downtime of | | in units of frame. | |
| current FA | | | |
| Expected | 8 | Expected uptime of new FA in | Optional |
| uptime of new | | units of superframe. | |
| FA | | | |
| } else if (Action | | | // multimode |
| Type == 0b111) | | | service end |
| { | | | |
| Expected time | 8 | Expected time in unit of LSB of | Optional |
| of backhaul | | superframe when the HR-MS | |
| link up | | releases the multimode service | |
| | | and allows subordinate MS | |
| | | to perform handover to other | |
| | | infrastructure. | |
| } | | | |

TABLE 21

| Syntax | Size (bit) | Notes |
|---|---|---|
| MM-ADV message | — | — |
| format ( ) { | | |
| Management Message | 8 | — |
| Type = xx | | |
| Action Type | 3 | Used to indicate the purpose of |
| | | this message. |
| | | 0b000: Reconfiguration of |
| | | HR-BS/RS including multimode |
| | | BS/RS |
| | | 0b001: Restart of HR-BS/RS |
| | | including multimode BS/RS |
| | | 0b010: Power down (including FA |
| | | down) of HR-BS/RS including |
| | | multimode BS/RS |
| | | 0b011: Power reduction of |
| | | HR-BS/RS including multimode |
| | | BS/RS |
| | | 0b100: Backhaul link down of |
| | | HR-BS |
| | | 0b101: Backhaul link up of HR-BS |
| | | 0b110: FA change of HR-BS/RS |
| | | including multimode BS/RS |
| | | 0b111: Multimode service end of |
| | | HR-MS |
| reserved | 5 | |
| TLV encodings for | variable | TLV-specific |
| MM-ADV | | |
| } | | |

The MM-ADV includes, particularly, a corresponding situation and a start time point, an end time point, and a situation duration of a corresponding situation, and transmits the corresponding situation and the start time point, the end time point, and the situation duration of the corresponding situation to a subordinate apparatus.

As shown in Tables 20 and 21, when PHY/MAC configuration information is changed, the control message includes the changed information and may be transmitted. Further, even when transmission power is changed, the control message includes the changed transmission power and may be transmitted, and when one of a plurality of frequencies is unavailable, the control message may include corresponding frequency information and an unavailable period.

Table 20 represents a reason for information transmission, i.e., an action type with only one transmission reason, but may complexly express a plurality of transmission reasons with a method of expressing a corresponding action type in a form of a bitmap and include information.

Thereafter, the subordinate apparatus 500, having received the MM-ADV, performs a continuous service by enabling an apparatus including a BS, an RS, or a multi-mode MS that transmits/receives data to perform handover to another apparatus with reference to unavailability and change periods of a service or waits until a time at which a corresponding apparatus resumes a service, and resumes a service (S530).

Particularly, when the MS terminates a role of a BS or an RS, the MS requests a subordinate apparatus to perform handover to another BS or an RS. When changing a function of an MS to a role of a BS and an RS, by transmitting information of a subordinate apparatus to an MS to perform a role of a corresponding BS and RS, handover can be efficiently performed.

Further, when the MS terminates a role of a BS or an RS, the MS performs only an original function thereof and thus the MS may be set to prevent another cell or an MS to perform initial access from connecting, and for example, sets a cell bar bit within SFH of IEEE 802.16m and transmits the MM-ADV.

Further, an RS, an MS that performs a role of an RS, or a BS that establishes a relay link due to a disconnection of a backhaul link receives changed system configuration information from a superordinate BS through a relay link and transmits a MM-ADV that is suggested in the present invention. Corresponding system configuration information may be forwarded in a process of setting a relay link.

In another exemplary embodiment, a BS or an RS to which a relay link is established, a BS or an RS that operates in a network, or a multi-mode MS acting as a BS may notify a subordinate MS that the BS, the RS, or the multi-mode MS operates in a multi-mode. In this case, the state may be included in the MM-ADV, but connection of an MS attempting to enter from the outside may be prevented or may be limited. In order to perform this, a cell bar bit may be set within SFH of IEEE 802.16m or another field may be newly defined, for example, may be newly included in SFH or SCD, or may be included within DCD of IEEE 802.16-2009. Further, by allocating a specific preamble index to an MS having no backhaul link in a network or acting as an RS or a BS, a corresponding fact may be notified to a subordinate MS or an MS that is scheduled to enter. In order to previously limit entry, a method NBR-ADV of notifying information including information of an adjacent BS may be used. Further, in order to limit entry, when scanning an adjacent BS, different conditions from those of a general BS and RS may be notified to a subordinate MS.

TLV that is shown in Table 21 exists in a form of Table 22, and includes the following information.

TABLE 22

| Name | Type | Length | Value |
|---|---|---|---|
| Time to | 1 | 1 | Start time of the action in unit of 8-bit LSBs |
| start the | | | of frame number. |
| action | | | Indicates the unavailable time due to |
| | | | reconfiguration 0b000, restart 0b001, |
| | | | power down 0b010, backhaul link down |
| | | | 0b100, or FA change 0b110. |
| | | | It also indicates the time for power |
| | | | reduction 0b011 or expected backhaul |
| | | | linkup 0b111. |
| Time | 2 | 1 | Time for the action in unit of 8-bit LSBs of |
| during | | | frame number. |
| action | | | If acting type is set to 0b000, 0b001, or |
| | | | 0b100, it is the unavailable time interval. |
| | | | After this time, during action, the BS will |
| | | | reconfigure 0b000, restart service 0b001, |
| | | | or backhaul link available either by itself or |
| | | | via a neighbor HR-BS 0b100. |
| DCD | 3 | variable | The DCD_setting is a compound TLV |
| setting | | | value that encapsulates TLVs from the BS' |
| | | | DCD message that may be transmitted in |
| | | | the advertised BS downlink channel after |
| | | | reconfiguration. |
| UCD | 4 | variable | The UCD_setting is a compound TLV |
| setting | | | value that encapsulates TLVs from the BS' |
| | | | UCD message that may be transmitted in |
| | | | the advertised BS downlink channel after |
| | | | reconfiguration. |

When an action type is 0b000, 0b001, 0b010, and 0b011, a “time to start the action” is included, and additionally, even when an action type is 0b101, 0b110, and 0b110, a “time to start the action” may be included. In this case, the time to start the action is a time point at which a corresponding situation occurs and indicates a frame number or an LSB of a frame number.

Further, when an action type is 0b000, 0b001, and 0b011, a time during action is included, and additionally, even when an action type is 0b010, 0b100, and 0b110, a time during action may be added. In this case, the time during action indicates a time at which a corresponding situation occurs.

When an action type is 0b000, a new PHY/MAC parameter change value is included, and a previous value is updated to a new value.

When an action type is 0b011, reduced transmission power may be included.

When an action type is 0b110, a changed frequency allocation index (FA index) is included and thus a frequency allocation change may be performed.

According to the present exemplary embodiment, in a communication system, when an MS performs a role of a BS or an RS, a method of transmitting a control message is provided, and by continuously performing a transmission service, communication can be smoothly maintained.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of relaying in a base station (BS), the method comprising:
establishing, when a backhaul link of a first BS is damaged, a relay link using a second BS, which is an adjacent BS of the first BS as a serving BS; and
releasing the relay link after the backhaul link is recovered.

2. The method of claim 1, wherein the release of the relay link comprises transmitting, by the second BS, a handover request message that requests the first BS to perform handover to a terminal (MS).

3. The method of claim 1, wherein the release of the relay link is performed through the recovered backhaul link.

4. The method of claim 1, wherein an MS waits until the first BS operates as a BS, and when the first BS operates as a BS, the MS performs network reentry.

5. A method of relaying in a BS, the method comprising:
establishing, when a backhaul link of a first BS is damaged, a relay link between a first BS and a second BS, which is a serving BS; and
notifying, by the first BS, the second BS that the backhaul link is recovered,
wherein the notifying of the second BS is performed through the recovered backhaul link.

6. A method of relaying in a BS, the method comprising:
scanning, when a backhaul link of a first BS is damaged, a downlink channel;
synchronizing with a second BS that is connected to the backhaul link;
acquiring a downlink parameter or an uplink parameter;
performing ranging; and
forming an operation parameter necessary for a relay link.

7. The method of claim 6, further comprising:
performing authentication, authority verification, and password exchange, if necessary; and
performing re-registration with the second BS, if necessary.

8. A method of relaying in a BS, the method comprising:
establishing, by a first BS, a relay link with a second BS that is connected to a backhaul link; and
providing, by the first BS, a service.

9. The method of claim 8, further comprising notifying a subordinate apparatus to perform handover of establishing of the relay link, if necessary.

10. A method of relaying in a BS, the method comprising:
transmitting, by a first BS in which a backhaul link is damaged, a relay establishment request message to a second BS in which a backhaul link is connected; and
receiving, by the first BS, a relay establishment response message comprising acceptance, rejection, or re-request from the second BS.

11. A method of relaying in an MS, the method comprising:
reporting, by the MS, a capability of the MS to perform a role of a relay station (RS) to a BS; and
performing, by the MS, a role of the RS.

12. The method of claim 11, wherein the reporting of a capability of the MS is performed in a process in which the MS performs initial access, and
the performing of a role of the RS is determined by the BS.

13. A method of relaying in an MS, the method comprising:
receiving, by the MS, a relay establishment request message from a BS; and
transmitting, by the MS, a relay establishment response message to the BS.

14. The method of claim 13, wherein the relay establishment request message comprises a relay mode comprising a time-division transmit & receive (TTR) mode or a simultaneous transmit & receive (STR) mode.

15. The method of claim 13, further comprising operating, by the MS, as an RS as a relay link is set to the MS,
wherein the operating as an RS comprises maintaining, by the MS, a function of the MS.

16. A method of relaying in an MS, the method comprising:
transmitting, by the MS to which a relay link is established, a relay link release request message to a BS; and
receiving, by the MS, a relay link release response message from the BS.

17. The method of claim 16, wherein the relay link release response message comprises an action time, and
the method further comprises transmitting, by the MS, a re-request to the BS after the action time has expired.

18. The method of claim 17, wherein the MS releases a relay mode immediately or after the action time is complete, after the relay link release response message is received.

19. The method of claim 16, wherein the relay link release response message comprises a rejection, and
the MS maintains the relay link when the MS receives the rejection.

20. A method of transmitting in an MS, the method comprising:
operating the MS in a multi-mode; and
transmitting a control message for supporting the multi-mode to a subordinate apparatus.

21. The method of claim 20, wherein the transmitting of a control message is performed when a backhaul link is damaged or recovered.

22. The method of claim 20, wherein the transmitting of a control message is performed in at least one of when a backhaul link is damaged or recovered, when it is necessary to reconfigure a parameter of at least one of a physical layer PHY and an MAC layer while the MS maintains a relay link as the backhaul link is unavailable, and when notifying establishment, release, or a change of the multi-mode to the subordinate apparatus, and
when it is necessary to reconfigure a parameter of at least one of a physical layer PHY and a MAC layer, it comprises at least one of power down, power reduction, and a frequency allocation (FA) change.

23. A method of transmitting in a BS, the method comprising:
operating the BS in a multi-mode; and
transmitting a control message for supporting the multi-mode to a subordinate apparatus.

24. The method of claim 23, wherein the transmitting of a control message is performed in at least one of when a backhaul link is damaged or recovered, when it is necessary to reconfigure a parameter of at least one of a physical layer PHY and a MAC layer while the MS maintains a relay link as the backhaul link is unavailable, and when notifying establishment, release, or a change of the multi-mode to the subordinate apparatus, and
when it is necessary to reconfigure a parameter of at least one of a physical layer PHY and an MAC layer, it comprises at least one of power down, power reduction, and an FA change.
